(19) United States
(12) Patent Application Publication
(10) Pub. No.: US 2022/0269284 A1
(43) Pub. Date: Aug. 25, 2022

(54) SYSTEMS AND METHODS FOR MANAGEMENT OF A ROBOT FLEET

(71) Applicant: Yokogawa Electric Corporation, Tokyo (JP)

(72) Inventors: Penny Pei CHEN, McLean, VA (US); Sandra FABIANO, Irving, TX (US); David Deacon EMERSON, Coppell, TX (US); Brendon Bao-An LU, Parker, TX (US); Stephen Andrew HAYDEN, Houston, TX (US); Saurabh BHANDARI, Singapore (SG); Yosuke ISHII, Tokyo (JP); Naoyuki FUJIMOTO, Addison, TX (US); Yukiyo AKISADA, Tokyo (JP); Yasuki SAKURAI, Tokyo (JP); Bradley FORD, Moskva (RU); Qian JINSONG, Singapore (SG); Renjila Elinjikottil RAJAN, Singapore (SG); Mark Anthony De Castro CU-UNJIENG, Singapore (SG)

(73) Assignee: Yokogawa Electric Corporation, Tokyo (JP)

(21) Appl. No.: 17/245,104

(22) Filed: Apr. 30, 2021

Related U.S. Application Data
(60) Provisional application No. 63/152,734, filed on Feb. 23, 2021.

(51) Int. Cl. G05D 1/02; G05D 1/00

(52) U.S. Cl. CPC G05D 1/0291; G05D 1/0027

(57) ABSTRACT

A system or a method includes defining missions based on factors associated with the missions or environmental data associated with the system, assigning the missions to the fleet of robots based on capabilities of the robots, generating a schedule of the missions and the robots, and managing the fleet of robots using feedback.

### TECHNICAL FIELD

Various embodiments of the present disclosure relate generally to management of robot services in, for example, industrial facilities and, more particularly, to receiving, defining, assigning, and managing missions performed by a fleet of robots.

### BACKGROUND

Industrial facilities, such as chemical factories, petroleum refineries, power generation plants, etc., may be extremely large and may involve a large number of simultaneous ongoing processes spread throughout the facility. Some aspects of these processes may be managed remotely by operators in a central control room, but other aspects require completion of tasks at various locations in the facility. These tasks may include monitoring and adjusting equipment, sensing environmental or other conditions within the facility, etc. Some of these tasks may require attention on a 24-hour per day schedule, and other tasks may require exposure to potentially hazardous conditions or work in spaces that are confined or otherwise difficult to access. Increasingly, facility operators are turning to robots for the completion of industrial tasks to, for example, reduce costs, increase facility up time, or protect human workers from potentially hazardous conditions. However, the range of required tasks in a complex facility may require a number of robots of varying types and capabilities provided by different manufacturers. These robots may not operate according to common protocols or commands, and may not communicate data by similar methods. Accordingly, integrating robot fleets into industrial facilities may become increasing complex as the number of robots and robot-assigned tasks increase. This complexity may be a significant barrier to the adoption of robots in industrial facilities.

The present disclosure is directed to overcoming, among other things, one or more of these above-referenced challenges.

### SUMMARY OF THE DISCLOSURE

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that robots and other operators may be assigned to tasks in an efficient manner that may maximize the use of robots and other operators available to perform the tasks within the facility. The disclosed systems and methods discussed below may allow missions to be designed, assigned, and monitored based on all available robot or operator types, capabilities of the robots or other operators, and feedback, for example.

It is to be understood that both the foregoing general description and the following detailed description are exemplary and explanatory only and are not restrictive of the disclosed embodiments, as claimed.

According to an aspect, a system for management of a robot fleet includes a plurality of robots including a first robot of a first robot type and a second robot of a second robot type; and a robot service platform comprising a first data adapter corresponding to the first robot type and configured to transform mission feedback gathered by the first robot to a common data format compatible with the robot service platform, a second data adapter corresponding to the second robot type and configured to transform mission feedback gathered by the second robot to the common data format, a first control adapter corresponding to the first robot type and configured to transform common mission control information to first robot mission control information compatible with the first robot, a second control adapter corresponding to the second robot type and configured to transform the common mission control information to second robot mission control information compatible with the second robot, and a mission manager. The mission manager is configured to select the first robot, from among the plurality of robots, to perform a selected robot mission among a plurality of robot missions based on capabilities of the first robot and features of the selected robot mission, transmit first robot mission control information to the first robot via the first control adapter, the first control adapter having transformed the first common robot mission control information to the transmitted first robot mission control information, and receive, from the first data adapter, mission feedback transformed by the first data adapter from data obtained by the first robot.

The mission manager may be further configured to select the second robot, from among the plurality of robots, to perform the selected robot mission based on capabilities of the second robot and features of the selected robot mission, transmit second robot mission control information to the second robot via the second control adapter, the second control adapter having transformed the first common robot mission control information to the transmitted second robot mission control information, and receive, via the second data adapter, mission feedback gathered by the second robot.

The mission manager may consider the first robot and the second robot for performance of at least part of the selected robot mission and selects the second robot to perform the at least part of the selected robot mission instead of the first robot.

The mission manager may consider the first robot and the second robot for performance of at least part of the selected robot mission and selects the second robot to perform the at least part of the selected robot mission in cooperation with the first robot.

The second data adapter may be distinct from the first data adapter, and the second control adapter may be distinct from the first control adapter.

The received mission feedback may include one or more of information that the selected robot mission was fully completed, information that the selected robot mission was partially completed, information that the selected robot mission was not initiated, health information about the first robot, status information about the first robot, capabilities information about the first robot, photographs, video, environmental data, sensor readings, motion data about the first robot, and location data about the first robot.

The first robot mission control information transmitted to the first robot may include one or more of multi-step mission instructions or individual operation instructions, the individual operation instructions including one or more of navigate to a destination, take a photograph, take a video recording, take a sound recording, take an environmental measurement, take a temperature measurement of a substance, take a temperature measurement of the air, take a humidity measurement, determine an instrument reading, measure a presence or concentration of a gas or chemical, emit light of a particular wavelength, intensity, and/or emission pattern, emit sound of a particular pitch, intensity, and/or emission pattern, emit a radio frequency homing beacon, transmit stored data via a radio frequency or wireless data network, connect to a power source, connect to a radio frequency or wireless data network, connect to a data network port, modify a setting of a valve or other control, adjust a position of a valve, vane, locally controlled pump or drive, take a product sample, press a button, change a switch position, move an object, stop all operations, return to home, or activate a sensor.

According to another aspect, a robot service platform for management of a robot fleet is configured to select a first robot, from among a plurality of robots, to perform a robot mission, select, from among a plurality of data adapters, a first data adapter corresponding to a first robot type of the first robot, the first data adapter being configured to transform mission feedback gathered by the first robot to a common data format, select, from among a plurality of control adapters, a first control adapter corresponding to the first robot type, the first control adapter being configured to transform common mission control information to first robot mission control information compatible with the first robot, transmit the first robot mission control information to the first robot via the first control adapter, the first control adapter having transformed the first common robot mission control information to the transmitted first robot mission control information, and receive, via the first data adapter, mission feedback gathered by the first robot.

The robot service platform may be further configured to select a second robot, from among the plurality of robots, to perform the robot mission, select, from among the plurality of data adapters, a second data adapter corresponding to a second robot type, the second data adapter being configured to transform mission feedback gathered by the second robot to the common data format, wherein the second data adapter is distinct from the first data adapter, select, from among the plurality of control adapters, a second control adapter corresponding to the second robot type, the second control adapter being configured to transform common mission control information to second robot mission control information compatible with the second robot, wherein the second control adapter is distinct from the first control adapter, transmit the second robot mission control information to the second robot via the second control adapter, the second control adapter having transformed the first common robot mission control information to the transmitted second robot mission control information, and receive, via the second data adapter, mission feedback gathered by the second robot.

The robot service platform may consider the first robot and the second robot for performance of at least part of the selected robot mission and selects the second robot to perform the at least part of the robot mission instead of the first robot.

The robot service platform may consider the first robot and the second robot for performance of at least part of the selected robot mission and selects the second robot to perform at least part of the robot mission in cooperation with the first robot.

The robot service platform may select the first robot to perform the robot mission based on capabilities of the first robot and features of the robot mission.

The robot service platform may select the second robot to perform the robot mission based on capabilities of second robot and features of the robot mission.

The received mission feedback gathered by the first robot may include one or more of information that the selected robot mission was fully completed, information that the selected robot mission was partially completed, information that the selected robot mission was not initiated, health information about the first robot, status information about the first robot, capabilities information about the first robot, photographs, video, environmental data, sensor readings, motion data about the first robot, and location data about the first robot.

The first robot mission control information transmitted to the first robot may include one or more of multi-step mission instructions or individual operation instructions, the individual operation instructions including one or more of navigate to a destination, take a photograph, take a video recording, take a sound recording, take an environmental measurement, take a temperature measurement of a substance, take a temperature measurement of the air, take a humidity measurement, determine an instrument reading, measure a presence or concentration of a gas or chemical, emit light of a particular wavelength, intensity, and/or emission pattern, emit sound of a particular pitch, intensity, and/or emission pattern, emit a radio frequency homing beacon, transmit stored data via a radio frequency or wireless data network, connect to a power source, connect to a radio frequency or wireless data network, connect to a data network port, modify a setting of a valve or other control, adjust a position of a valve, vane, locally controlled pump or drive, take a product sample, press a button, change a switch position, move an object, stop all operations, return to home, or activate a sensor.

According to an another aspect, an adapter for management of a robot fleet comprises a data adapter corresponding to a first robot type, the data adapter being configured to transform data gathered by the first robot to a common data format compatible with a robot service platform, and a control adapter corresponding to the first robot type, the control adapter being configured to transform common mission control information to robot mission control information compatible with the first robot.

Mission feedback gathered by the first robot may include one or more of information that a robot mission was fully completed, information that the robot mission was partially completed, information that the robot mission was not initiated, health information about the first robot, status information about the first robot, capabilities information about the first robot, photographs, video, environmental data, sensor readings, motion data about a robot, and location data about the robot.

The robot mission control information may include one or more of multi-step mission instructions or individual operation instructions, the individual operation instructions including one or more of navigate to a destination, take a photograph, take a video recording, take a sound recording, take an environmental measurement, take a temperature measurement of a substance, take a temperature measurement of the air, take a humidity measurement, determine an instrument reading, measure a presence or concentration of a gas or chemical, emit light of a particular wavelength, intensity, and/or emission pattern, emit sound of a particular pitch, intensity, and/or emission pattern, emit a radio frequency homing beacon, transmit stored data via a radio frequency or wireless data network, connect to a power source, connect to a radio frequency or wireless data network, connect to a data network port, modify a setting of a valve or other control, adjust a position of a valve, vane, locally controlled pump or drive, take a product sample, press a button, change a switch position, move an object, stop all operations, return to home, or activate a sensor.

The adapter may be configured to communicate with robots of a specific type or robots produced by a single manufacturer.

The adapter may be configured to communicate with robots of multiple types or robots produced by multiple manufacturers.

According to an aspect, a computer-implemented method of managing a robot fleet comprises obtaining features of a plurality of robot missions, obtaining capabilities of a plurality of robots of the robot fleet, selecting a robot among the plurality of robots to perform a selected robot mission among the plurality of robot missions based on the obtained capabilities of the selected robot and the obtained features of the selected robot mission, sending robot mission control information for the selected robot mission to the selected robot, receiving mission feedback for the selected robot mission from the selected robot, storing the received mission feedback to a database, sending the received mission feedback to an information analysis module, receiving an analysis result from the information analysis module, and sending the analysis result to an operation management system.

The robot mission control information for the selected robot mission may be sent to the selected robot via a control adapter configured to transform common mission control information to robot mission control information.

The mission feedback for the selected robot mission and the analysis result of the mission feedback may be received from the selected robot via a data adapter configured to transform mission feedback gathered by the selected robot to a common data format.

The information analysis module may perform data aggregation and analysis of the mission feedback.

The data aggregation and analysis of the mission feedback may include one or more of processing of photograph information, determining an instrument reading from photograph information, comparing a sensor reading to a prior or expected sensor reading, and performing statistical analysis on mission feedback.

Data aggregation and analysis of the mission feedback may be performed using machine learning or artificial intelligence analysis of mission feedback from prior robot missions or the analysis results of mission feedback from prior robot missions.

The method may further include selecting a second robot among the plurality of robots to perform the selected robot mission in cooperation with the robot, and receiving second mission feedback for the selected robot mission and a second analysis result of the mission feedback from the second robot, wherein the second mission feedback for the selected robot mission and the second analysis result of the mission feedback may be received from the second robot via a second data adapter configured to transform second mission feedback gathered by the second robot to a common data format.

According to aspect, a computer-implemented method for management of a robot fleet comprises obtaining features of a plurality of robot missions, obtaining capabilities of a plurality of robots, selecting a robot among the plurality of robots to perform a selected robot mission among the plurality of robot missions based on the obtained capabilities of the selected robot and the obtained features of the selected robot mission, sending robot mission control information for the selected robot mission to the selected robot, receiving mission feedback for the selected robot mission and an analysis result of the mission feedback from the selected robot, and sending the analysis result to an operation management system.

The analysis result of the mission feedback may be data aggregation and analysis of the mission feedback performed by the robot.

Data aggregation and analysis of the mission feedback may be performed using machine learning or artificial intelligence analysis of mission feedback from prior robot missions or the analysis results of mission feedback from prior robot missions.

The robot mission control information for the selected robot mission may be sent to the selected robot via a computer network, the computer network being one of a global network, a virtual private network, or a local network.

The robot mission control information for the selected robot mission may be sent to the selected robot via a server.

The method may further include processing the robot mission control information for the selected robot mission by a first robot interface, corresponding to a first robot type, prior to sending the robot mission control information for the selected robot mission to the selected robot.

The method may further include processing the robot mission control information for the selected robot mission by a first robot control adapter corresponding to the first robot type configured to transform common robot mission control information to robot mission control information prior to processing the robot mission control information for the selected robot mission by the first robot interface.

According to another aspect, a system for management of a robot fleet comprises a plurality of robots, and a robot service platform comprising a data storage device storing instructions for management of a robot fleet in an electronic storage medium, and a processor configured to execute the instructions to perform a method including obtaining features of a plurality of robot missions, obtaining capabilities of the plurality of robots, selecting a robot among the plurality of robots to perform a selected robot mission among the plurality of robot missions based on the obtained capabilities of the selected robot and the obtained features of the selected robot mission, sending mission control information for the selected robot mission to the selected robot, receiving mission feedback for the selected robot mission from the selected robot, storing the received mission feedback to a database, sending the received mission feedback to an information analysis module, receiving an analysis result from the information analysis module, and sending the analysis result to an operation management system.

Storing the received mission feedback to the database may include one or more of providing the received mission feedback to a machine learning (ML) and artificial intelligence (Al) module for further analysis of mission feedback from prior robot missions or the analysis results of mission feedback from prior robot missions, providing the received mission feedback to a report generator, or storing a record of the mission and the received mission feedback to a mission log.

The mission feedback may be received from the selected robot via a data adapter configured to transform mission feedback gathered by the selected robot to a common data format compatible with the robot service platform.

The system may further include processing the mission feedback by a robot interface prior to processing by the data adapter.

The mission feedback for the selected robot mission may include one or more of information that the selected robot mission was fully completed, information that the selected robot mission was partially completed, information that the selected robot mission was not initiated, health information about the selected robot, status information about the selected robot, capabilities information about the selected robot, photographs, video, environmental data, sensor readings, motion data about the selected robot, or location data about the selected robot.

The mission feedback and analysis result from the information analysis module may be provided to an end user application, the end user application being one of an operations management application, a maintenance application, a field inspection application, or a workflow management application.

According to another aspect, a computer-implemented method of managing a fleet of robots comprises receiving one or more missions, each mission from the one or more missions including a mission profile, determining robots associated with a system, determining at least one capability of each robot associated with the system, assigning the one or more missions to one or more of the robots associated with the system based on the at least one capability, and generating a mission schedule based on the assigned one or more missions to the one or more robots.

The at least one capability may be stored in a memory of the robot, wherein determining the at least one capability of the robot may include transmitting the at least one capability from the robot to a memory or a processor of the system, and wherein the at least one capability may include an ability of the robot to perform a task, an availability of the robot, an amount of battery charge of the robot, one or more tools associated with the robot, or one or more materials of the robot.

Each mission profile may include at least one factor related to information for performance of the respective mission, and wherein a robot from the one or more robots may be assigned, by a processor of the system, to a mission from the one or more missions if the at least one capability of the robot is capable of satisfying at least a portion of the at least one factor such that the robot can perform at least a portion of the respective mission.

The method may further include determining, by a processor of the system, at least one environmental data of a facility, wherein assigning the one or more missions to the one or more robots may be also based on the at least one environmental data, wherein determining the at least one environmental data includes the processor of the system receiving data from at least one or more sensors or from a third party connected to the system via a wired or a wireless connection.

The at least one environmental data may include at least one of a pressure, a temperature, a humidity, a weather condition, a noise level, a noise type, a vibration, a presence of a substance, or a level of a substance.

The one or more missions may include a plurality of missions capable of being assigned to a plurality of robots from the one or more robots, wherein each mission profile may include one or more priorities each having a desired level of importance to the mission, and wherein the assigning the one or more missions may further include assigning the one or more missions based on the one or more priorities.

The one or more priorities may include one or more of a degree of quality of performance of each mission in a mission profile, a cost of each mission in the mission profile, and an amount of energy to be used in each mission of the mission profile, wherein the one or more priorities are stored in a memory of the system and are transmitted to the processor of the system to determine the prioritized mission.

The method may further include determining, by a processor of the system, a plurality of mission schedules, wherein the plurality of missions are assigned by the processor of the system to different robots of the plurality of robots in each of the plurality of mission schedules, determining, by the processor of the system, a prioritized mission schedule from the plurality of mission schedules, based on the one or more priorities, and initiating, by the processor of the system or by a processor of each of the plurality of robots, the plurality of missions of the prioritized mission schedule.

The method may further include receiving, by one or more of a processor of the system or a processor of a robot, a feedback from a robot of the one or more robots, wherein the feedback is transmitted via a wired or a wireless connection, and modifying, by the processor of the system, the mission profile of a first mission from the one or more missions based on the feedback, wherein the feedback is received by a processor of a first robot scheduled to perform the first mission, and wherein modifying the mission profile prevents the first robot from completing the first mission.

According to another aspect, a computer-implemented method of managing a fleet of robots comprises receiving a first mission, assigning the first mission to a first robot, determining a mission schedule based on the assigning of the first mission to the first robot, instructing the first robot to perform the first mission, based on the mission schedule, receiving feedback from the first robot, and assigning a second mission to a second robot, different from the first robot, based on the feedback.

The first mission may be defined by a first mission profile stored in one or more of a memory of the first robot or a memory of the second robot, and wherein the step of assigning may further comprise updating, by a processor of the system or a processor of the first robot, data in the first mission profile based on the feedback, and generating, by the processor of the system or the processor of the first robot, a second mission profile based on the updated first mission profile, wherein the second mission may be defined by the second mission profile, wherein the second robot may be capable of performing at least a portion of the second mission, and wherein the first robot may be incapable of performing at least a portion of the second mission.

The method may further include comparing, by the processor of the system or a processor of the second robot, one or more capabilities of the second robot to the second mission profile, wherein the second robot may be capable of performing at least the portion of the second mission based on the one or more capabilities of the second robot matching factors for completing the portion of the second mission.

The feedback may indicate a change to at least one of a factor for performing the first mission or an environmental data in an environment in which the fleet of robots is configured to operate, and wherein generating the second mission profile may include changing the at least one factor for performing the first mission based on the feedback.

The environmental data may include one or more of pressure, temperature, a type of gas, presence or absence of stairs, humidity, a weather condition, a noise level, a noise type, a vibration, or a substance.

A third mission, different from the first mission and the second mission, may be assigned, by the processor of the system, to the first robot or the second robot, and wherein the mission schedule may be updated, by the processor of the system, based on assigning the second mission and the third mission.

The method may further include determining, by the processor of the system, if the second robot is capable of completing the second mission, and assigning the second mission to at least a third robot, different from the first robot and the second robot, if capabilities of the second robot prevent the second robot from completing the second mission.

According to another aspect, a computer-implemented method of managing a fleet of robots comprises receiving one or more missions, each mission including a mission profile, wherein the mission profile includes environmental data from one or more sensors, for each of the one or more missions, determining one or more robots capable of completing the one or more missions based on the mission profile included in the mission, scheduling, as a primary schedule, the one or more missions to be performed by the one or more robots, receiving feedback indicating a change in the environmental data, the feedback obtained by a robot from the one or more robots performing one or more of the scheduled missions, and scheduling, as a secondary schedule, the one or more missions to the one or more robots based on the feedback.

The method may further include determining, by a processor of the system, a robot capability of a first robot, determining, by the processor of the system, if the robot capability of the first robot satisfies features in a mission profile defining a first mission, wherein the robot capability of the first robot of the one or more robots scheduled to perform the first mission of the one or more missions may be unsuitable for operating in an environment defined by the change in the environmental data, and the method may further comprise assigning, by the processor of the system, the first mission to a second robot.

A processor of a first robot may obtain the feedback, and the feedback may be obtained separate from data gathered based on a mission assigned to the first robot.

The scheduling the one or more missions of the primary schedule may include assigning, by the processor of the system, a first mission from the one or more missions to a first robot, wherein the scheduling of the secondary schedule based on the feedback may further include determining, by the processor of the system, a second robot capable of performing a portion of the first mission, and assigning the second robot to the first mission, wherein the second robot is configured to assist the first robot to accomplish the mission based on the change in environmental data.

According to another aspect, a computer-implemented method of managing a fleet of robots comprises receiving a first task, determining at least one factor for the first task indicating information related to accomplishing the first task, receiving data indicating information related to an environment in which the first task is to be accomplished, determining at least one mission capability for accomplishing a mission that includes the first task, wherein the at least one mission capability is based on one or more of the at least one factor or the data, and creating a mission profile based on the first task and one or more of the at least one factor, the data, or the at least one mission capability.

The mission may include a plurality of tasks including the first task, and wherein the at least one factor may include an order in which the plurality of tasks are to be performed.

The method may further include receiving, by a processor of a system in which the fleet of robots is configured to operate, a second task, different from the first task, determining, by the processor of the system, at least one factor for the second task, wherein the at least one factor associated with the first task and the second task may instruct an order in which the first task is to be completed relative to the second task, creating, by the processor of the system a second mission profile based on the second task and the at least one factor of the second task.

The method may further include receiving, by the processor of the system, a capability of one or more robots from the one or more robots, determining, by the processor of the system, if the capability of the one or more robots enables the one or more robots to perform the first task and the second task in the order indicated by the factor of each of the first task and the second task, and if the one or more robots are capable of performing the first task and the second task in the order specified, assigning, by the processor of the system, the first task and the second task to the one or more robots.

The mission may include a plurality of tasks, and the mission profile includes a sub-mission profile for each of the plurality of tasks.

The method may further include assigning, by a processor of a system in which the fleet of robots is configured to operate, the mission to a first robot, receiving feedback, by one or more of the processor of the system or a processor of a robot from the fleet of robots, wherein the feedback may include information relating to an object along a route for accessing a location of a step in the mission, a position of the object preventing the robot from accessing the location via the route, receiving, by the processor of the system, map data to determine one or more routes for accessing the location of a step of the task, and altering, by the processor of the system, the data in the mission profile, wherein altering the data in the mission profile causes the mission assigned to the first robot to be rescheduled, such that the first robot performs the mission in an order relative to all other missions assigned to the first robot based on the altered data.

The method may further include determining, by a processor of a system in which the fleet of robots is configured to operate, the fleet of robots, receiving, by the processor of the system, for each robot in the fleet of robots, a robot capability defining a feature of the respective robot, wherein the robot capability is transmitted from the respective robot or a storage storing capabilities of the fleet of robots to the processor of the system, determining, by the processor of the system, if the at least one mission capability of the mission matches the robot capability of a robot selected from the fleet of robots, and assigning, by the processor of the system, the mission to the selected robot if the mission capability of the at least one mission that matches the robot capability of the selected robot.

The method may further include receiving, by a processor of a system in which the fleet of robots is configured to operate, a feedback, and updating, by the processor of the system, the mission profile based on the feedback, wherein the feedback may indicate a change to one or more of the at least one factor, the data, or the at least one mission capability.

The mission profile may be defined in a system computer code language specific to a system for managing the fleet of robots.

The method may further include determining, by a processor of a system in which the fleet of robots is configured to operate, the fleet of robots, determining, by the processor of the system, a robot computer code language of each robot of the fleet of robots, and for each robot that does not support the system computer code language, translating, by the processor of the system, the mission profile to the robot computer code language.

According to an aspect, a computer-implemented method of managing a fleet of robots comprises receiving a first mission, including factors related to performance of the first mission, determining data relating to an environment in which the first mission is performed, instructing one or more robots of the fleet of robots to perform the first mission, receiving feedback during performance of the first mission, wherein the feedback includes information relating to the environment, and revising the first mission based on the feedback, wherein revising the first mission causes at least one robot from the one or more robots to alter a scheduled operation.

The method may further include defining, by a processor of a system in which the fleet of robots is configured to operate, a second mission based on the feedback.

The feedback may include information relating to an object along a route for accessing a location of a step in the mission, a position of the object preventing the robot from accessing the location via the route, the method may further include receiving, by a processor of a system in which the fleet of robots is configured to operate, map data to determine one or more routes for accessing the location of a task, wherein altering the scheduled operation includes rescheduling the first missions assigned to the robot, including the first mission, such that the robot performs the missions in a shortest time period.

The environment feedback may include information relating to an object positioned along a route for accessing a location of a step in the first mission, the object positioned such that the object prevents the robot from accessing the location via the route, the method may further include revising, by a processor of a system in which the fleet of robots is configured to operate, the mission schedule to remove the first mission from the mission schedule, receiving, by the processor of the system, at least one robot capability from each of one or more robots, determining, by the processor of the system, a second robot from the one or more robots having a robot capability that enables the second robot to (1) operate in the environment of the mission and (2) perform the first mission to completion, and reassigning, by the processor of the system, the first mission removed from the mission schedule to the second robot.

Revising the first mission may include transmitting data between one or more of a processor of the system in which the fleet of robots is configured to operate, a processor of the first robot, and a processor of a second robot, determining, by the processor of the system, the second robot to perform the first mission, and wherein both the first robot and the second robot may be required to perform the first mission.

One of the first robot or the second robot may enable the other of the first robot or the second robot to access a location of a step of the first mission, and the other of the first robot or the second robot may be configured to perform the step.

According to another aspect, a computer-implemented method of managing a fleet of robots comprises receiving a first mission defined by a plurality of tasks to be performed during the first mission, determining a first factor for the first mission, wherein the first factor includes a chronological order in which the plurality of tasks are to be performed, creating an original mission profile based on the first factor, receiving feedback from a system, wherein the system includes the fleet of robots, and modifying the original mission profile based on the feedback, wherein the feedback includes a change in the chronological order of the plurality of tasks.

The feedback may be received by a robot from the fleet of robots scheduled to perform the first mission, the method may further comprise causing, by a processor of the robot, the robot to perform the plurality of tasks in a chronological order different from the chronological order in the original mission profile.

The method may further comprise assigning, by a processor of a system in which the fleet of robots is configured to operate, the first mission to a first robot from the fleet of robots, wherein the feedback further includes a change in a second factor related to the plurality of tasks, receiving, by the processor of the system, capabilities of the first robot from the first robot, and if the capabilities of the first robot do not enable the first robot to perform the plurality of tasks of the first mission based on the updated second factor, assigning, by the processor of the system, the first mission to a second robot, different from the first robot, capable of performing the plurality of tasks of the first mission based on the updated information.

The first factor may include information related to a tool package that a robot from the fleet of robots is capable of using to achieve the plurality of tasks, and wherein the feedback may include a change to the tool package.

According to an aspect, a computer-implemented method of managing a fleet of robots comprises receiving a first mission profile including information relating to performance of a task, determining capabilities of one or more robots of the fleet of robots, assigning a first mission defined by the first mission profile to a first robot of the one or more robots based on the capabilities of the one or more robots and the information in the mission profile, instructing the first robot to perform the task based on the information in the mission profile, receiving data obtained from performance of the task by the first robot, and defining a second mission profile based on the received data, wherein the second mission profile includes information relating to performance of the task.

The information relating to performance of the task may include historical data, stored in a memory of the system configured to manage the fleet of robots, related to past missions in which the task was performed.

The historical data may include an environmental data received by a processor of the system configured to manage the fleet of robots, the environmental data may be transmitted from at least one or more sensors or from a third party connected to the system via a wired or a wireless connection.

The environmental data may include a feature that changes over time, the method may further include receiving, by the processor of the system, periodic updates from the at least one or more sensors or from the third party relating to the environmental data.

The environmental data may include a value of an environmental measurement of a location of the task, wherein a range of the value may be determined based on historical data, and wherein the task may be performed when a measured value of the environmental measurement is within a predetermined range.

The method may further include determining, by a processor of the system configured to manage the fleet of robots, if the capabilities of the first robot enable the first robot to perform all factors of the second mission profile, and if the first robot is incapable of performing all factors of the second mission profile, assigning, by the processor of the system, a second mission defined by the second mission profile to a second robot, different from the first robot.

The method may further include receiving, by at least one of a processor of the system configured to manage the fleet of robots or a processor of a robot, feedback from a system in which the fleet of robots is configured to operate, monitoring, by at least the processor of the system or the processor of the robot receiving the feedback, the first mission, updating, by at least the processor of the system or the processor of the robot receiving the feedback, the first mission profile automatically based on a change to a factor in the first mission profile due to the received feedback, determining, by at least the processor of the system or the processor of the robot receiving the feedback, if the capabilities of the first robot enable the first robot to perform all factors of the first mission based on the updated first mission profile, if the first robot is incapable of performing the first mission based on the updated first mission profile, determining, by at least the processor of the system or the processor of the robot receiving the feedback, a robot from the plurality of robots having a capability to perform a second mission based on the updated mission profile, and assigning, by at least the processor of the system or the processor of the robot receiving the feedback, the second mission to the robot capable of performing the second mission.

A mission schedule of the robot capable of performing the second mission may be revised, by at least the processor of the system or the processor of the robot receiving the feedback, based on the assignment of the second mission.

The method may further include determining, by at least one of a processor of the system configured to manage the fleet of robots or a processor of a robot, if the capabilities of the first robot enable the first robot to perform all factors of the second mission profile, and if the capabilities of the first robot do not enable the first robot to perform every step of the second mission, assigning, by at least the processor of the system or the processor of the robot receiving the feedback, the first robot and a second robot to the second mission, wherein the second robot is capable of enabling the first robot to complete all steps of the second mission.

The second mission may be further assigned to a second robot by at least one of a processor of the system configured to manage the fleet of robots or a processor of a robot, wherein the first robot and the second robot may be configured to coordinate to complete the second mission.

According to another aspect, a computer-implemented method of managing a fleet of robots comprises receiving a first mission profile, wherein the first mission profile includes information relating to performance of a task, determining capabilities of one or more robots, assigning the task to a first robot of the one or more robots based on the capabilities of the one or more robots and the information in the first mission profile, instructing the first robot to perform the task based on the information in the mission profile, receiving data obtained from performance of the task by the first robot, defining a second mission profile by modifying the first mission profile based on the received data, and instructing the first robot to perform the task based on the information in the second mission profile.

The method may further include if the first robot is incapable of performing the task based on the second mission profile, determining, by a processor of the system configured to manage the fleet of robots, if a second robot of the one or more robots is capable of performing the task based on the second mission profile, and assigning, by the processor of the system, the task based on the second mission profile to the second robot based on the capabilities of the second robot.

The second mission may be assigned, by the processor of the system, to the second robot based on a proximity of the second robot to a location of the task.

The method may further include if the first robot is incapable of performing a portion of the task, determining, by at least one of a processor of the system configured to manage the fleet of robots or a processor of the first robot, if a second robot from the one or more robots is capable of performing the portion of the task, and scheduling, by at least one of the processor of the system or the processor of the first robot, the first robot and the second robot to perform the second mission based on the second mission profile.

A processor of the first robot may continue to receive data while performing the task based on the second mission profile, wherein the method may further include determining, by at least one of a processor of the system configured to manage the fleet of robots or the processor of the first robot, if the first robot is incapable of performing a portion of the task based on the received data, if the first robot is incapable of performing the portion of the task, defining, by at least one of the processor of the system or the processor of the first robot, a third mission profile based on the received data, determining, by at least one of the processor of the system or the processor of the first robot, a second robot capable of performing the task based on the third mission profile, and instructing, by at least one of the processor of the system or the processor of the first robot, the second robot to perform the task based on the third mission profile.

The third mission profile may include historical data based on a past performance of the task.

According to another aspect, a computer-implemented method of managing a fleet of robots comprises receiving a first mission profile, determining capabilities of one or more robots of the fleet of robots, assigning a task to a first robot from the one or more robots based on the capabilities of the one or more robots and the first mission profile, instructing the first robot to perform the task based on information in the mission profile, receiving data obtained from performance of the task by a second robot, wherein the data is historical data related to the task, defining a second mission profile by modifying the first mission profile based on the historical data, and instructing the first robot to perform the task based on information in the second mission profile.

The task may include instructing, by a processor of the system configured to manage the fleet of robots, a third robot to alter a mission schedule based on instructions from a central database.

The method may include receiving, by a processor of the system configured to manage the fleet of robots, environmental data, and modifying, by the processor of the system, the first mission profile based on the environmental data before instructing the first robot to perform the task.

If modifying the first mission profile based on the environmental data causes the first robot being incapable of performing the task, the method may further include determining, by a processor of the system configured to manage the fleet of robots, if the second robot is capable of performing the task based on the environmental data if capabilities of the second robot enable the second robot to navigate an environment defined by the environmental data; and instructing, by the processor of the system, the second robot to perform the task if the second robot is capable of performing the task based on the environmental data.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary mobile robot in an industrial facility setting 100;

FIG. 2 depicts tasks and components of an operations management system for an industrial facility;

FIG. 3 depicts a generalized model of robotics activity within an operations management system;

FIG. 4 depicts components of a robotics services platform within an operations management system, according to one or more embodiments;

FIG. 5 depicts a detailed architecture of a multivendor robotic services platform, according to one or more embodiments;

FIG. 6 further depicts a detailed architecture of a multivendor robotic services platform and associated components, according to one or more embodiments;

FIG. 7 depicts subsystems of an operations management system including a multivendor robotic services platform, according to one or more embodiments;

FIG. 8 depicts an environment for robot control and communication within a multivendor robotic services platform, according to one or more embodiments;

FIG. 9 depicts a process of planning, assigning, and executing robotic tasks within a multivendor robotic services platform, according to one or more embodiments;

FIG. 10 depicts a flowchart for a high-level method for management of a robot fleet, according to an example;

FIG. 11 depicts a flowchart for a high-level method for defining a mission during the management of the robot fleet in FIG. 10;

FIG. 12 depicts a flowchart for a high-level method for assigning a mission during the management of the robot fleet in FIG. 10;

FIG. 13 depicts a flowchart for a high-level method for managing a mission during the management of the robot fleet in FIG. 10;

FIG. 14 depicts a dashboard for entering and displaying data, according to an example;

FIG. 15 depicts an example of the dashboard of FIG. 14, according to an example;

FIG. 16 depicts a flowchart for assigning missions based on priority, according to an example;

FIGS. 17 and 18 depict flowcharts for managing a robot fleet, according to an example;

FIGS. 19 and 20 depict flowcharts for managing a robot fleet, according to another example;

FIGS. 21 and 22 depict flowcharts for managing a robot fleet, according to yet another example;

FIGS. 23 and 24 depict flowcharts for managing a robot fleet, according to an example;

FIG. 25 depicts a flowchart for defining a mission using machine learning, according to an example;

FIG. 26 depicts a flowchart for assigning a mission using machine learning, according to an example;

FIG. 27 depicts a flowchart for receiving feedback, according to an example;

FIG. 28 depicts a flowchart for receiving feedback, according to another example;

FIG. 29 depicts a flowchart for reassigning a mission, according to an example;

FIG. 30 depicts a user input, according to an example;

FIG. 31 depicts a template for defining a mission, according to an example;

FIGS. 32A and 32B depict sensors within the facility of FIG. 1, according to an example

FIG. 33 depicts a feedback from a mission, according to an example;

and

FIG. 34 depicts a flowchart for reassigning a mission, according to an example.

### DETAILED DESCRIPTION OF EMBODIMENTS

Various embodiments of the present disclosure relate generally to management of robot services in, for example, industrial facilities and, more particularly, to receiving, defining, assigning, and managing missions performed by a fleet of robots, managing data gathered by such robots, and managing other associated systems.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Industrial facilities, such as chemical factories, petroleum refineries, power generation plants, manufacturing facilities, etc., may be extremely large and may involve a large number of simultaneous ongoing processes spread throughout the facility. Some aspects of these processes may be managed remotely by operators in a central control room, but other aspects may require completion of tasks at various locations in the facility. These tasks may include monitoring and adjusting equipment, sensing environmental or other conditions within the facility, performing manufacturing tasks, etc. Some of these tasks may require attention on a 24-hour per day schedule, and others may require exposure to potentially hazardous conditions or work in spaces that are confined or otherwise difficult to access. Increasingly, facility operators are turning to autonomous mobile robots for the completion of these tasks. Some of these tasks may be possible to be achieved through specialized sensors or actuators at several locations throughout the plant, but may not be prioritized due to cost, complexity or other considerations.

Systems for Managing a Robot Fleet

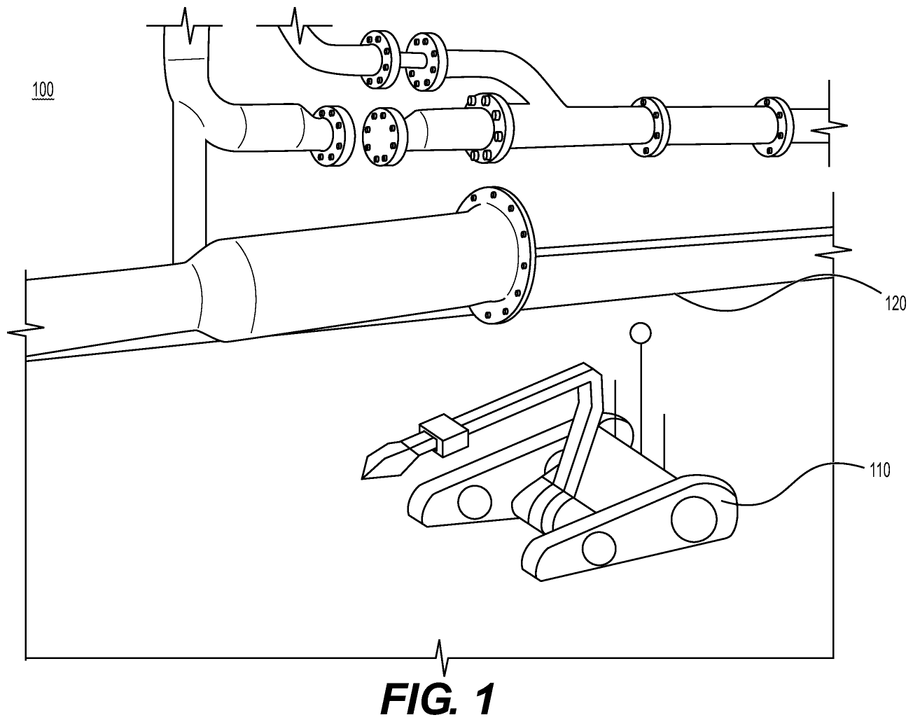

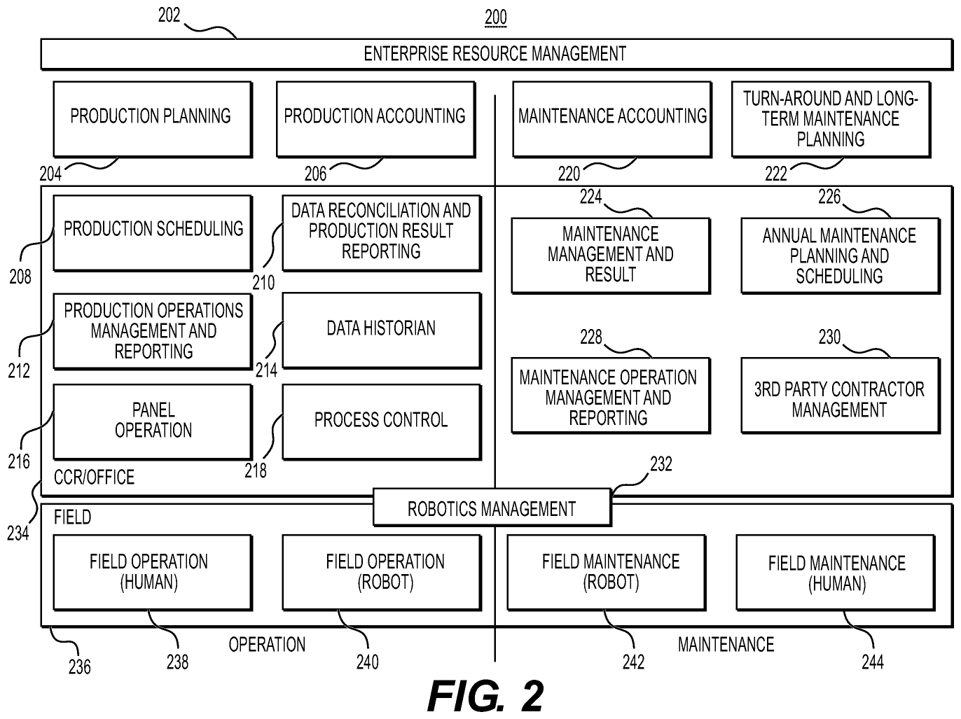

FIG. 1 depicts such an exemplary mobile robot 110 in an industrial facility 120 of an industrial facility setting 100. The operation of the industrial facility 120 may be controlled by an operations management system operated by one or more human operators. FIG. 2 depicts tasks and components of an operations management system 200 for the industrial facility 120.

Operation of industrial facility 120 may include tasks and components related to operation of the facility, monitoring of safety or other conditions within the facility, and maintenance of the facility. Overall operations may be managed by an enterprise resource management system 202, which may control tasks such as, for example, production planning 204, production accounting 206, maintenance accounting 220, and planning of both turn-around maintenance and long-term maintenance 222.

Tasks for the operation and maintenance of the industrial facility 120 may be performed in an operations office or central control room (CCR) 234, or in the field 236, such as within the production area of the industrial facility 120 itself.

Operations-related tasks performed within the office/CCR 234 may include, for example, production scheduling 208, data reconciliation and production result reporting 210, production operations management and reporting 212, a data historian 214, panel operation 216, and process control 218.

Maintenance-related tasks performed within the office/CCR 234 may include, for example, maintenance and reliability management, and result reporting 224, annual maintenance planning and scheduling 226, maintenance operation management and reporting 228, and third party contractor management 230.

Operations-related tasks performed in the field 236 may include, for example, human-performed operations tasks 238 and robot-performed operations tasks 240. Maintenance-related tasks performed in the field 236 may include, for example, human-performed maintenance tasks 242, and robot-performed maintenance tasks 244.

Robot-performed operations tasks 240 and robot-performed maintenance tasks 244, as well as other robot-performed tasks, may be managed by a robotics management system 232. Exemplary embodiments of one or more such robotics management systems will be discussed in greater detail below.

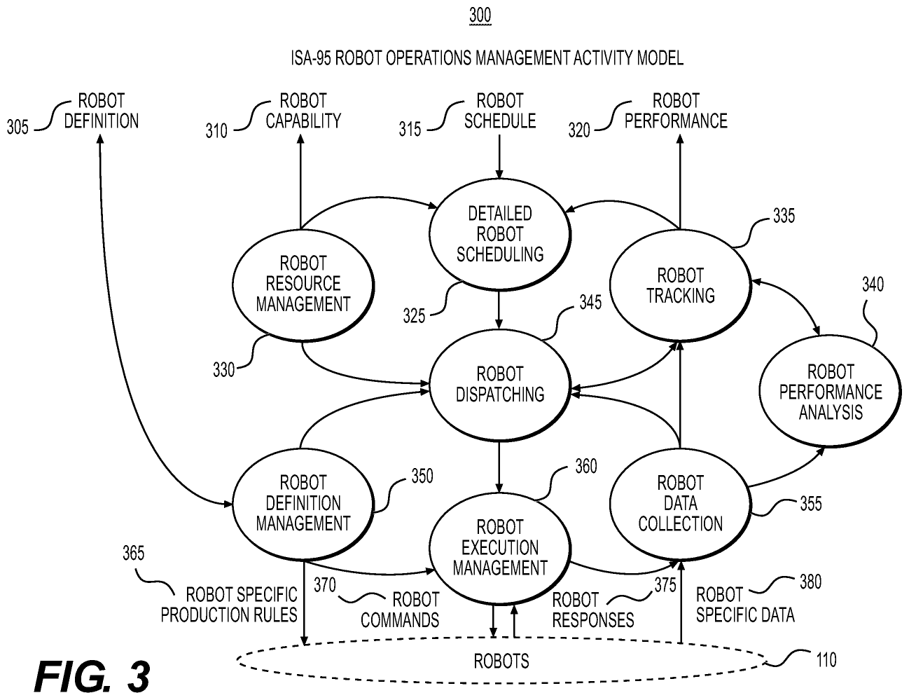

Robots acting within an operations management system may require additional information and metadata about each of the robots and robot activities within the system, including robot management, tracking, and analysis of the robots and their activities. For example, robots may require information about other robots and their activities when multiple robots are cooperating on an activity or when the activities of multiple robots may conflict. FIG. 3 depicts a generalized model 300 of robotics activity within an operations management system, based on the ISA-95 standard for “Enterprise-Control System Integration” (https://www.isa.org/standards-and-publications/isa-standards/isa-standards-committees/isa95).

Management of robots 110 functioning within an industrial facility 120, including robot-performed operations tasks 240 and robot-performed maintenance tasks 244, may relate to activities performed by robots 110, data related to robots 110 and the tasks performed, operations performed by robotics management system 232, and communications between the robotics management system 232 and the robots 110. Such management may be structured according to model of robotics activity 300.

Data related to the robots 110 may include, for example, a robot definition 305 for each robot 110, a robot capability 310 for each robot 110, a robot schedule 315 for each robot 110, and robot performance metrics 320 for each robot 110.

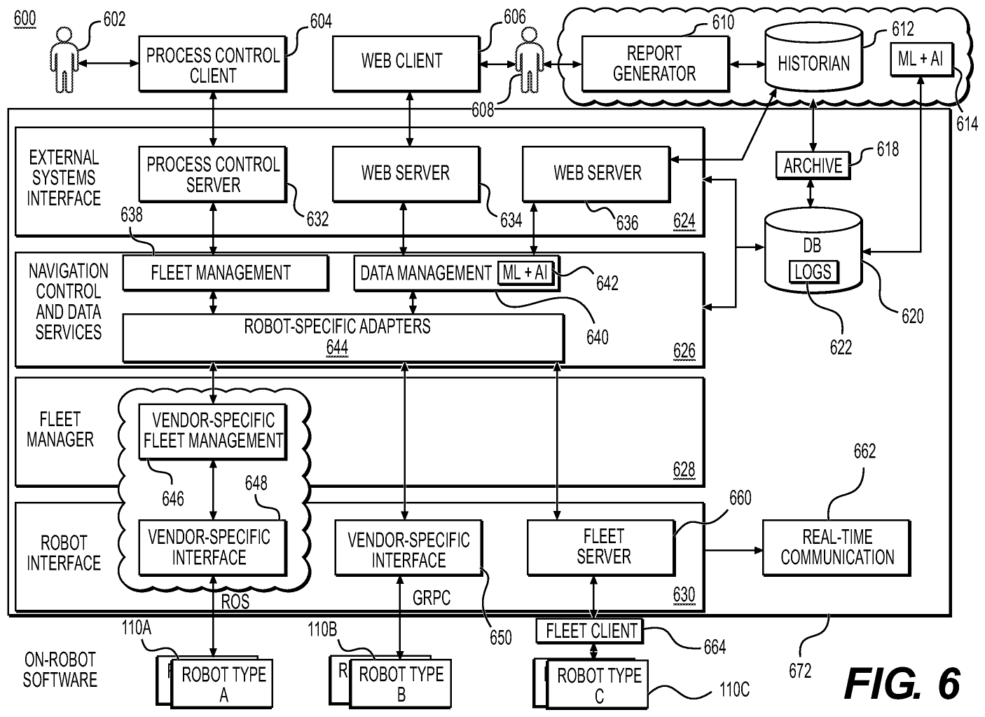

Operations performed by robotics management system 232 may include, for example, robot resource management 330, robot definition management 350, detailed robot scheduling 325, robot dispatching 345, robot execution management 360, robot tracking 335, robot data collection 355, and robot performance analysis 340. In a system utilizing robots provided by multiple robot vendors, these operations may reflect differences between robots provided by different vendors. For example, each robot vendor may make data pertaining to each robot available in a different format particular to that robot or vendor. To address this, robotics management system 232 may standardize the data by pulling and interpreting a subset of data that may be relevant to a human operator. For instance, two robots from different vendors may each have an error in a mission relating to a blockage, but the robots may format and present that error in different ways depending on their platform. Robotics management system 232 may correctly interpret the differing information presented by robots from multiple vendors via adapters, such as robot-specific adapters 644 discussed below with respect to FIG. 6.

During robot resource management 330, robotics management system 232 may update or refer to robot capability information 310 to maintain information about available robot resources and make those resources available for robot-assigned tasks. For example, during the course of performing missions or tasks, the capabilities of a robot may temporarily change, such as the depletion of the robot's battery, damage or malfunction of one or more tools or sensors attached to the robot, removal or replacement of one or more tools or sensors attached to the robot, or other changes to a robot's capabilities. In addition, a robot may become unable to move from a current location, due to an obstruction, environmental conditions (e.g., heavy rainfall for a robot not protected from wet conditions), damage to a robot's track, leg, or other means of propulsion, a loss of connectivity to robot management system 232 or other plant systems, etc. In addition, a robot working in extreme heat, such as in a desert environment, may overheat a component of the robot. Similarly, a robot working in extreme cold may affect the operation of a joint or other moving parts. Such temperature extremes may shorten the life of a robot's battery. Robotics management system 232 may monitor the robot's condition and maintain robot capability information 310 to reflect such changes and make decisions on how to schedule or re-schedule the fleet of robots for the best performance. In some embodiments, an operator or technician may be responsible for updating robot capability information 310 for robotics management system 232. Each robot may also (or alternatively) report capability information, including payload status, to the robotics management system 232 prior to mission execution. If the robotics management system 232 determines that the payload capabilities of a robot are insufficient for a mission, robotics management system 232 may select a different robot for the mission and update the specific robot capabilities. Robotics management system 232 may check future scheduled missions against updated robot capabilities. If no other capable robot is available at the time a mission is to be run, then a robot payload may be changed, replaced, and/or updated to allow for the mission to run. Such a change, replacement, or update may impact the availability of the robot during a time in which the mission was initially intended or scheduled to be run. The mission may indicate a period of time, or other recurring circumstances in which a mission may be performed. In such a case, the mission may be rescheduled to run at a later time under conditions suitable for the mission. To avoid rescheduling, robotics management system 232 may verify robot status in advance of the start of the mission (the time needed will be dependent on the facility and personnel). This verification may require a pre-check, which may also include checks of camera, microphone, sensor, payload, and/or other capabilities of the robot. This may be done for all robots, including those with mutable and immutable sensors.

During robot definition management 350, robotics management system 232 may maintain robot definition information and may transmit robot-specific production rules 365 to robots 110. For example, in addition to the temporary changes in robot capabilities discussed above, a particular robot may be subject to permanent changes in capabilities and availability, such as the removal or installation of sensors or tools, or the relocation of the robot another area of a facility such that the robot is available to perform missions or tasks in a different limited portion of the facility. Modifications to a robot may change other capabilities of the robot, such as, for example, changes to the total weight of the robot may cause changes to battery life, movement speed, or maximum distance for the robot to travel. Such changes may be reflected in updated robot definition information. During detailed robot scheduling 325, robotics management system 232 may determine and update information about an overall robot schedule. Robot scheduling will be discussed in greater detail below. During robot dispatching 345, robotics management system 232 may release selected robots 110 to perform robot-assigned tasks. Robot dispatching will be discussed in greater detail below. During robot execution management 360, robotics management system 232 may transmit robot commands 370 to robot 110 and may receive responses 375 from robot 110. Robot activity commands and data collection will be discussed in greater detail below. During robot tracking 335, robotics management system 232 may maintain information about robot location, status, and performance during robot-assigned activities or during idle periods. Robot tracking will be discussed in greater detail below. During robot data collection 355, robotics management system 232 may receive robot-specific data 380 from robot 110. Robot data collection will be discussed in greater detail below.

During robot performance analysis 340, robotics management system 232 may perform analysis of robot performance in the completion of robot-assigned tasks. This analysis may include updates to information for robot definition 305 and robot capability 310 to improve the performance of robot-assigned tasks. For example, the time taken for a robot to complete a mission or task, or a portion of a mission or task, such as traveling from one place to another, traveling stairs or a ramp, may be measured. In addition, the accuracy of measurements and data (e.g., photographs, or other data) gathered by the robot may be monitored to determine if the robot generally returns accurate measurements and data. Such information may be taken into account when planning a mission or task for the robot in the future, or may be used to determine that the robot is in need of maintenance. In addition, a task assigned to a robot may be modified after scheduling, during execution, or as a result of execution. Circumstances around the mission may change, necessitating such a modification. For example, as a result of opening a door, a change in temperature or air composition may be detected, such that a different sensor is needed to provide accurate and actionable feedback regarding the environment around the mission. As another example, a measured temperature may be lower than expected, such that opening a manual valve may require a higher torque than can be applied by the original robot assigned to the task.

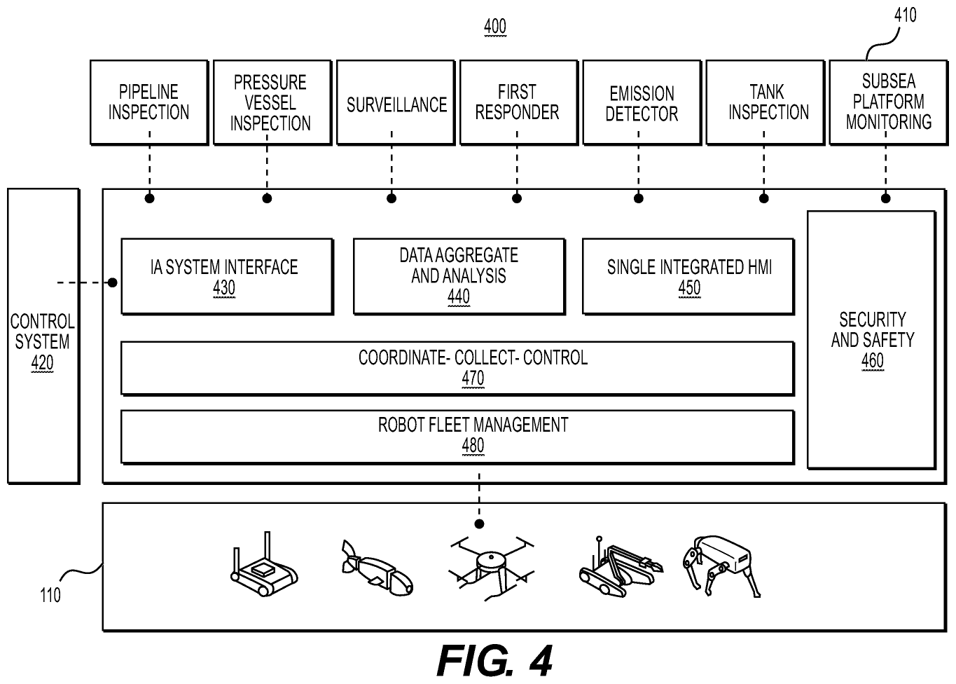

As discussed above, an operations management system may interact with a robotics management system, such as a robotics services platform (RSP) to manage robots 110 and robot-assigned tasks. FIG. 4 depicts components of a robotics services platform (RSP) 400 within, or otherwise in communication with, an operations management system, according to one or more embodiments.

Activities of robots 110 within an operations management system 200 may relate to a variety of industrial operations 410 including, for example, pipeline inspection, pressure vessel inspection, surveillance, first responder, emission detection, tank inspection, and subsea platform monitoring. The identified operations 410 are only exemplary; the principles of this disclosure may pertain to any facility suitable for professional services to be carried out by a robotic fleet in dynamic environments. Such services may be repetitive and/or dangerous for human operators that may have previously placed human operators into such roles in reliance on human ability to recognize and adjust to the dynamic environment. Such dynamic environments may require the robotics services platform to recognize and adjust the activity of individual robots or the robot fleet to meet changing circumstances, or to operate in environments that may not be designed for robotic operations, while managing a fleet of robots of varying technical and operational capabilities. For example, applicable facilities may include chemical and pharmaceutical manufacturing, mining, food and beverage production, water and wastewater treatment, etc. To support these operations, RSP 400 may receive commands from an external control system 420, such as operations management system 200 or an industrial automation (IA) system, and may, for example, include modules for interfacing with an industrial automation system 430, for data aggregation and analysis 440, for security and safety 460, for coordinating operations, collecting data, and controlling robots 470, and for robot fleet management 480. Access to these modules may be provided to a human operator by way of an integrated human-machine interface HMI, 450. Industrial automation system interface 430 may provide services for the automation of industrial processes, possibly in conjunction with an external industrial automation (IA) system. Data aggregation and analysis module 440 may receive data from robot-assigned tasks, and may support the aggregation and analysis of the data. Data aggregation and analysis will be discussed in greater detail below. Security and safety module 460 may ensure the safety and security of facility operations and of individual robots 110. Coordinate-collect-control module 470 may provide overall management of robot-assigned activities, coordination or robot-assigned activities, and collection of data returned from robot-assigned activities. Robot fleet management module 480 may provide management of a fleet of robots 110, including, for example, maintaining information about the current status, location, availability, and performance of individual robots 110, coordinating related or potentially conflicting activities of multiple robots 110, and coordinating required maintenance and/or removal of individual robots 110. Additional detail regarding robot management is provided herein.

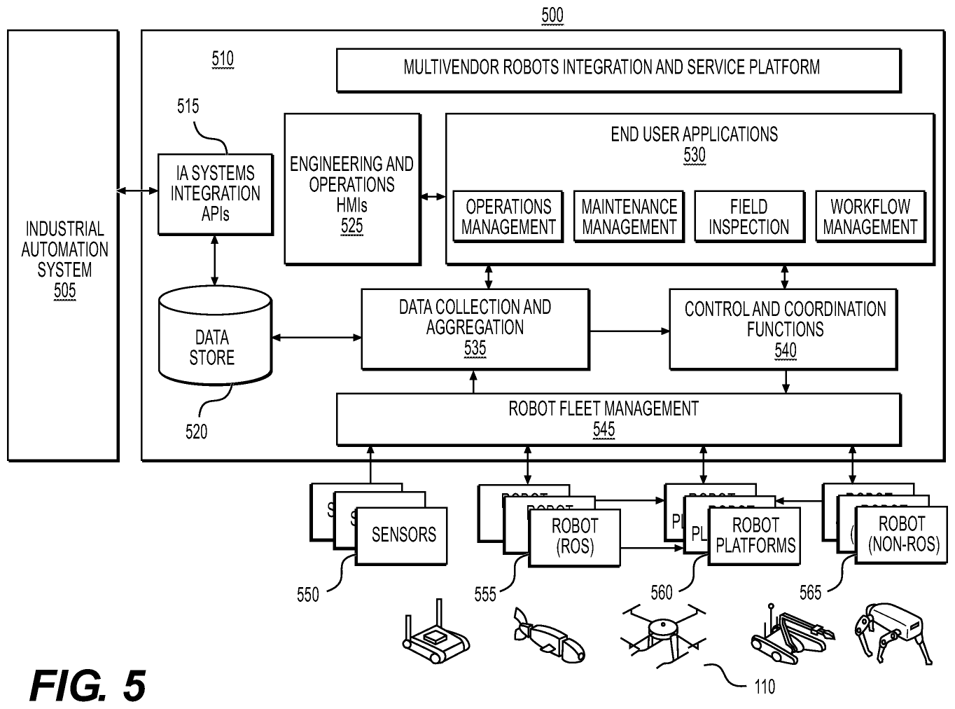

Managing robot activities in a large or complex industrial facility may require coordination of robots provided by multiple vendors, each having different, and potentially incompatible, command and control or data management and communication protocols. Accordingly, integrating robot fleets into industrial facilities may become increasing complex as the number of robots and robot-assigned tasks increase. FIG. 5 depicts a detailed architecture 500 of a multivendor robotic services platform 510 to address these issues, according to one or more embodiments.

Multivendor robotic services platform 510 may interface with an external control system, such as operations management (OM) system 200 or industrial automation (IA) system 505, by way of IA systems integration application programming interfaces (APIs) 515. Multivendor robotic services platform 510 may provide humans that manage, control, or otherwise oversee the robot fleet, with access to end user applications 530, such as, for example, operations management relating to the overall operation of the facility, maintenance management relating to activities for the maintenance of the facility, field inspection relating to the direct inspection of portions of the physical facility, and workflow management relating to coordinating multiple human and robot activities within the facility, by way of engineering and operations human-machine interfaces (HMIs) 525. An instruction for an activity from OM 200 may be a work instruction (WI) that may be directed for assignment to a human. Such an instruction may be in a human-readable format. Multivendor robotic services platform 510 may transform the WI to robot commands. If there are multiple types of robots from multiple vendors, translations may be performed differently for each type robot, as discussed elsewhere in this disclosure. If the activity is performed by a human, WIs may be assigned to operators in the context of shift planning. If the activity is to be assigned to a robot, robotic services platform 510 may autonomously translate and assign the WI to one or more robots, as discussed elsewhere in this disclosure. In other embodiments, if an alarm generates a robot mission, such as from an external application, then actions may be taken to ensure that a capable robot is available. For example, if the alarm is a critical alarm, robotic services platform 510 may determine to abort a current mission and handle the critical alarm mission if no robot or human is available. Alternatively, the operator may manually take over a robot to tend to the alarm. External systems may send a request for the performance of a task, and the robotic services platform 510 may reply with robot availability or mission starting information. Human and robot tasks may each include capability requirements for a human or robot assigned to the task, such as a requirement of being capable of working at a specified height above the ground, or a capability of using a particular tool. In addition, tasks may have requirements related to the operation status of the facility, such as time of day restrictions, a requirement that the plant not be in operation while the task is performed, or changes in governmental or other regulations governing operation of the facility. Robotic services platform 510 may segregate requests received from OM system 200 or IA system 505 into those that may be robot compatible tasks that may be sent to relevant robots to execute and those that may be robot incompatible tasks that may be returned to OM system 200 or IA system 505 for assignment to a human.

Robot fleet management module 545 may interact with a variety of robot platforms 560 supporting interaction with robots 110, as well as sensors 550 (e.g., environmental sensors). Robot platforms 560 may include platforms for interacting with open source robot operating systems 555, such as Robot Operating System (ROS), as well as vendor-specific (non-open source) robots 565. Robot fleet management module 545 may also interact directly with ROS robots 555 and non-ROS robots 565 rather than via robot platforms 560. The interaction between robot fleet management module 545 and robots 110 may include, for example, robot commands for mission and task completion based on information from control and coordination functions 540. The interaction between robot fleet management module 545 and robots 110 may further include, for example, collection of data and other information from robots 110 and sensors 550, which may be provided to data collection and aggregation module 535 for further processing. Such processing may include storing the collected and processed data in data store 520 and/or providing the collected and processed data to end user applications 530. Data stored in data store 520 may further be provided to (IA) system 505 by way of IA systems integration APIs 515. Coordination functions 540 may translate end user application functions into robot system functions. For example, if the end user requests an inspection of a gauge, then coordination functions 540 may translate that request into a robot mission to take a picture of the gauge. For example, coordination functions 540 may determine a robot mission including detailed steps such as navigating from the robot's current location to the location of the gauge, taking an image of the gauge, and returning either the image of the gauge or an analysis of the gauge reading based on the image. Other requested tasks would translate to other appropriate operations. To support robots from multiple vendors, the gauge mission may be preconfigured to support multiple robots by the robot fleet management module 545. For example, detailed operations corresponding to robots from multiple vendors may be pre-determined and stores. This may allow robot missions based on recurring task requests to be dispatched quickly or to be scheduled on a recurring basis. Coordination functions 540 may further coordinate robot tasks with operations being performed by other human and robot operators, such as steps being taken by operators in a control room, automated steps in the IA platform, and field operations. Each of these components work in tight synchronization to ensure proper operation of the facility. In conventional facilities, much of this synchronization may be conducted verbally; in a facility applying a robotic fleet, coordination functions 540 may integrate robots and automated systems into this synchronization. In some circumstances, complete control over a robot at all times may not be possible, and a robot may be allowed to operate semi-autonomously to use any particular capabilities of the robot to complete a task. Where multiple robots are assigned missions, coordination functions 540 may assign some missions with an appropriate time delay to avoid conflicts among robots operating in the same area.

In a facility with robots from multiple vendors, robot fleet management, such as may be provided by robot fleet management module 545, robot activity control, such as may be provided by control and coordination functions 540, and data analysis, such as may be provided by data collection and aggregation module 535, may utilize additional vendor-specific and robot-type-specific capabilities in a multivendor robotic services platform (RSP). FIG. 6 further depicts a detailed architecture 600 of a multivendor robotic services platform (RSP), according to one or more embodiments.

Robot services platform 672 may include, for example, external systems interface 624, navigation control and data services 626, fleet manager 628, and robot interface 630, etc.

External systems interface 624 may include, for example, process control server 632, which may receive information for processes and tasks to be completed from a process control client 604 under the direction of a human operations manager or operator 602. For example, the received missions and tasks may include activities to be performed by humans or robots relating to the overall operation of the facility, such as facility inspections, data collection, facility control (e.g., changing control settings), etc. External systems interface 624 may further include, for example, a first web server 634, which may provide data reports to a web client 606 for display to a human operator or analyst 608. External systems interface 624 may further include, for example, a second web server 636, which may provide data feeds to a historian data store 612.

Historian data store 612 may provide data to a report generator 610, which may provide additional reports to human operator or analyst 608. Historian data store 612 may further provide data to an archive module 618 for storage in a database 620 within the robot services platform 672. Database 620 may provide data to a machine learning (ML) and artificial intelligence (Al) module 614 for further analysis. Analysis results from ML and Al module 614 may be stored in database 620. Database 620 may further provide data to historian data store 612 for access by report generator 610. Report generator 610, historian data store 612, and ML and Al module 614 may be cloud-based, or may otherwise operate separately from robot services platform 672.

Navigation control and data services 626 may include, for example, robot-specific adapters 644, which may provide platform-independent command, control, and data services for robots 110A, 110B, and 110C. Robot-specific adapters 644 may include adapters for communication of data collected by robots 110, such as, for example, photos, video, environmental data, sensor readings, etc., adapters for communication of data about robots 110, such as, for example, robot motion and location, robot health and status, robot capabilities, etc., and adapters for communication of command and control information to and from robots 110, such as, for example, multi-step mission instructions, individual operation instructions (e.g., navigate to a destination, take a photograph, take a video recording, take a sound recording, take an environmental measurement, take a temperature measurement of a substance, take a temperature measurement of the air, take a humidity measurement, determine an instrument reading, measure a presence or concentration of a gas or chemical, emit light of a particular wavelength, intensity, and/or emission pattern, emit sound of a particular pitch, intensity, and/or emission pattern, emit a radio frequency homing beacon, transmit stored data via a radio frequency or wireless data network, connect to a power source, connect to a radio frequency or wireless data network, connect to a data network port, modify a setting of a valve or other control, such as by adjusting the position of a valve, vane, locally controlled pump, or drive, take a manual product sample, press a button, change a switch position, move an object, stop all operations, return to home, activate a particular sensor, etc.), etc. Robot-specific adapters 644 may also receive information from robots 110 including, for example, information about task or mission status and completion, non-data task completion information (e.g., mission complete or abandoned, etc.).

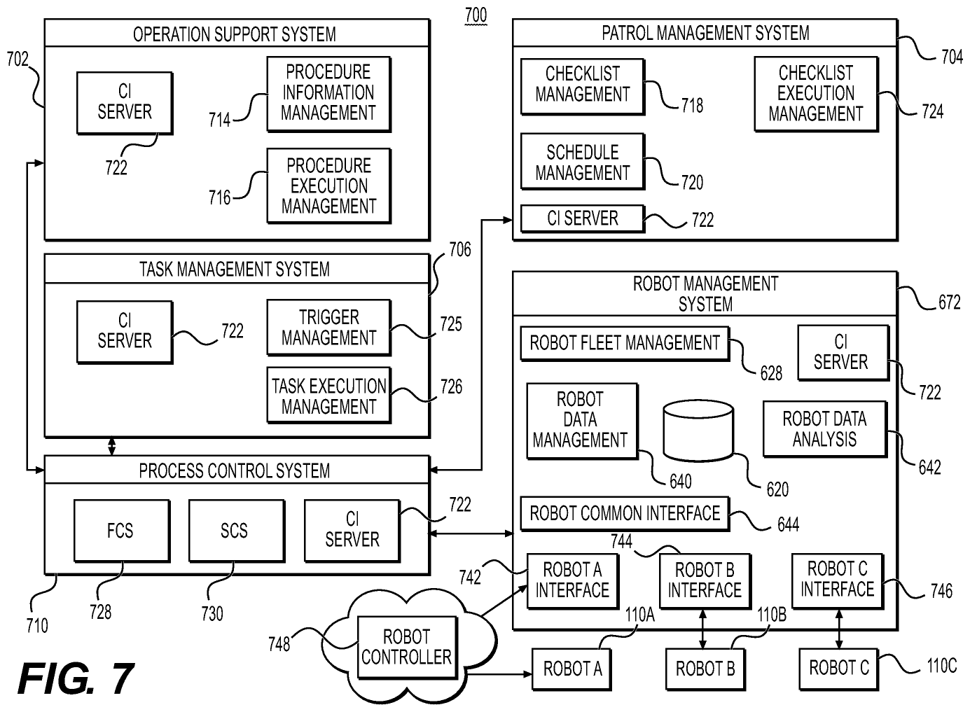

Command/control and data information may be maintained generally within RSP 672 in one or more common internal formats. This may allow the internal operations of RSP 672, and the interfaces and information shared outside of RSP 672, such as with other components of an operations management system (OM), to be independent of which robots or robot types are active in the facility. Thus, the complexity of utilizing a diverse fleet of robots within a facility may be reduced. To this end, each adapter may take in information from RSP 672 in one or more of the common internal formats, transform that information into a specific information suitable for the particular robot to which it will be communicated, and then transmit the transformed information to the particular robot. For example, a definition of a robot task or mission may be transformed from a common internal format to a format that conforms to the expected command protocols for the assigned robot. Conversely, data transmitted from a robot may be received by an adapter in a robot-specific format and be transformed by an adapter into a common internal format for use by RSP 672 and other components of an operations management system (OM), such as operations management system (OM) 700 described in FIG. 7. A common internal format for a definition of a robot task or mission may include a list of measurements or data to be captured within a facility. Adapters 644 may transform this list into robot-specific instructions that may include, for example, directions to physically travel to the data-capture locations and which instruments to use. Vendor specific robot data may also be parsed by the adapters 644 to detect generalized or useful information to display to an operator. For example, data such as battery life may be displayed in different ways (percentage/voltage remaining/time remaining) that may be parsed and standardized.

Some such adapters 644 may be narrowly adapted to communicate with particular robots according to robot type or vendor, while others may be compatible with multiple robot types. Adapters 644 may be considered fleet-specific adapters compatible with multiple robots of a same type and make operating concurrently or in cooperation. Adapters 644 may be manually coded based on the common internal data formats and information about data and command protocols for specific vendors and robots. Alternatively, such adapters may be automatically generated based on algorithmic or artificial intelligence processes. Adapters may be configured to provide equivalent levels of basic control across multiple robot types. This may include, for example, the capability of movement to specific points, data captures, and robot metric reporting. Adapters may further include added functionality depending on the robot vendor specific software limitations on each robot type. For example, if a robot is unable to log its metric data, the adapter may log the robot's metric data to maintain compatibility with a standard adapter level for other components of the platform. Common features from different robot types may be abstracted into a common internal data format, such as map data, simulation data on 3D models, etc. OM system 700 or IA system 505 may assign a work instruction (WI) checklist, which may be in a human readable format, such as a spreadsheet, etc., consisting of instructions to record information corresponding to various identifiers. RSP 672 may convert a WI checklist into detailed information, such as absolute or relative position and orientation information such as GPS coordinates, site specific visual, electronic or magnetic identifiers etc., for execution by robots. Unstructured data types recorded by robots, for example media formats such as image, sound or video, etc., may be further processed by RSP 672 using data processing applications into structured data types, such as text or numeric data compatible for storage and processing in OM system 700 or IA system 505.

Navigation control and data services 626 may further include, for example, fleet management module 638 to receive information for missions and tasks to be completed from process control server 632. Fleet management module 638 may determine which of robots 110A, 110B, and 110C should perform each task or mission, and may provide detailed information about robot tasks and missions to robot-specific adapters 644. Fleet management module 638 may also provide information about the progress or completion of missions and tasks to process control server 632. Navigation control and data services 626 may further include, for example, data management module 640, which may receive data from robots 110A, 110B, and 110C by way of robot-specific adapters 644. Data management module 640 may further include a machine learning (ML) and artificial intelligence (Al) module 642, which may further analyze data received from robots 110A, 110B, and 110C.

External systems interface 624 and navigation control and data services 626 may provide information about tasks dispatched to and performed by robots 110A, 110B, and 110C, task results returned by robots 110A, 110B, and 110C, and other information related to the management of robots 110A, 110B, and 110C, and missions performed by robots 110A, 110B, and 110C, to database 620. For example, a record of robot tasks and task results may be stored in logs 622 within database 620.

Fleet manager 628 may manage a fleet of robots 110A, 110B, and 110C with respect to, among other things, scheduling and dispatching missions and tasks to robots 110A, 110B, and 110C, monitoring the health and maintenance status of robots 110A, 110B, and 110C and their components, and scheduling maintenance of robots 110A, 110B, and 110C. Fleet manager 628 may include vendor specific fleet management module 646, which may provide management of robots 110A, 110B, and 110C that is specific to the vendor of one or more of robots 110A, 110B, and 110C. A separate vendor specific fleet management module 646 may be provided for each vendor-specific interface, such as vendor-specific interfaces 648 and 650. Fleet manager 628 may assign missions and tasks to robots 110 based on mission requirements and robot capabilities. For instance, if fleet manager 628 determines that a mission can be supported by only a robot type of type A, fleet manager 628 may assign the mission to only a robot among robots 110A, 110B, and 110C of type A. For example, a mission may require traversing obstacles, such as stairs, that can only be traversed by robots of a particular type. For another mission that can be assigned to a robot of type A or B, fleet manager 628 may assign the mission to a robot among robots 110A, 110B, and 110C of type A or B based on the availability of each robot 110A, 110B, and 110C. The availability of each robot 110A, 110B, and 110C may be determined by fleet manager 628 using metrics such as, for example, communications state and battery life, etc. In some embodiments, operations management system 200 may specify a mission or task to be performed by a specific robot or a robot among a specific group of robots. If a group of robots is specified, then fleet manager 628 may assign the mission to a selected robot among the specified group of robots. In addition, some attributes of a robot type or robots from a particular vendor may have a known reliability and fleet manager 628 may apply more or less direct monitoring of a robot based on this known reliability.

Robot interface 630 may include, for example, a first vendor-specific robot interface 648, a second vendor-specific robot interface 650, and a fleet server 660. Each of first vendor-specific robot interface 648 and second vendor-specific robot interface 650 may provide an interface to a robot that is specific to the vendor of that robot. For example, first vendor-specific robot interface 648 may interact with robot 110A by way of a robot operating system (ROS) interface, while second vendor-specific robot interface 650 may interact with robot 110B by way of a proprietary remote procedure call (RPC) interface. The number and types of vendor-specific robot interfaces provided by robot interface 630 is not limited, and may depend of the number and type of robots in the fleet of robots managed by robot services platform 672. Vendor specific interfaces are conventionally required to access these robots. That is, robots from each vendor typically have proprietary software and are gated using each vendor's application programming interfaces (APIs). For example, if a vendor uses gRPC calls to access their unique API to control a robot from that vendor, there may be no other alternative to communicate with or control the robot. Fleet server 660 may interact with a coordinated fleet of robots, such as robots 110C by way of fleet client 664. Robot interface 630 may further interact with real-time communication module 662 to provide additional communication streams to, for example, robots 110A, 110B, and 110C, human operations manager or operator 602, such as through process control server 632 or process control client 604, or other components of RSP 672. For real-time communication, robot interface 630 may support multiple types of protocols for streaming data. For example, WebRTC is a streaming protocol for high quality video/sound streaming that may be utilized for such communications. Such streaming may include, for example, receiving data to be displayed to an operator as well as performing real-time processing of the data using artificial intelligence (Al) or machine learning (ML) to support functions such as, for example, anomaly detection. Real time communication can be important for fleet management in order to execute different tasks. Some robots may have a capability to work during lost communication for a short period of time, while others may not. Fleet server 660 may need to frequently communicate with each robot based on the robot's capability and keep track of a robot during a mission.

Vendor-specific fleet manager module 646 and fleet server 660 may be cloud-based, or may otherwise operate separately from fleet manager 628 and robot interface 630.

Robots 110A, 110B, and 110C may be provided by different vendors and may be of multiple types, and may further have distinct instrumentation, tools, and sensors available. Each robot may maintain, possibly in conjunction with robot management and fleet management modules of RSP 672, information about the health and status of the robot 110, including battery or fuel levels, capabilities, locations, malfunctions, and maintenance requirements, etc.

Examples of robots 110A, 110B, and 110C may include robots that are fully autonomous, pre-programmed for specific tasks, motions, routes, or activities, or under direct human control. Robots 110A, 110B, and 110C may be stationary or mobile, and mobile robots may include wheeled, tracked, bi-ped, quadraped, or multi-ped, or other means of propulsion. Robots 110A, 110B, and 110C may be provided with tools, sensors, or other hardware for the completion of missions and tasks, such as articulated arms, grips, claws, wrenches, drivers, hammers, pry bars, cameras, microphones, chemical detectors, noise sensors, vibration sensors, etc. Robots 110A, 110B, and 110C may include digital and physical storage, such as for photographs, video, sound, environmental readings, environmental samples, such as soil, chemicals, etc. Robots 110A, 110B, and 110C may include various communications capabilities, including analog (radio and video transmission, etc.) and digital (Wi-Fi, Bluetooth, other near-field communication, etc.).

A robotic services platform, such as RSP 672, may interact with and depend upon other subsystems of an operations management system. FIG. 7 depicts subsystems of an operations management system 700 as well as a multivendor RSP, which may operate as part of or separate from, or otherwise in cooperation with, operations management system 700, according to one or more embodiments.

Operations management system 700 may include multiple subsystems to support the operation and management of an industrial facility. Such subsystems may include, for example, an operation support system 702, a patrol management system 704, a task management system 706, a process control system 710, and a robot management system or robot support platform (RSP) 672.

Process control system 710 may provide operations control and monitoring for a facility through control subsystems that may be distributed throughout the facility or located outside the facility. Process control system 710 may include, for example, a collaborative information server 722, which may support sharing information between process control system 710 and other subsystems of operations management system 700. Process control system 710 may also include a field control system 728, which may control processes within the facility and collect data from those processes data via field instruments, and a safety control system 730, which may monitor safety conditions of processes within the facility and may ensure that processes return to a safe state if deviations occur. Process control system 710 may coordinate with operation support system 702, patrol management system 704, task management system 706, a and robot management system or robot support platform (RSP) 672.

Operation support system 702 may provide services to support the overall operation of the facility. Operation support system 702 may include, for example, a collaborative information server 722, which may support sharing information between operation support system 702 and other subsystems of operations management system 700, a procedure information management module 714, which may store and manage information about procedures and processes for operating the industrial facility, and a procedure execution management module 716, which may manage execution of the procedures and processes.

Patrol management system 704 may provide services related to periodic patrol and monitoring of the facility with respect to operations, safety, and security. Patrol management system 704 may include, for example, a collaborative information server 722, which may support sharing information between patrol management system 704 and other subsystems of operations management system 700. Patrol management system 704 also may include a checklist management module 718, which may manage checklists to ensure that all operations, safety, and security protocols are sufficiently covered, a checklist execution management module 724, which may manage the execution of tasks to fulfill checklist requirements, such as may be determined by checklist management module 718, and a schedule management module 720, which may schedule the completion of checklist tasks. Checklists and associated checklist tasks may be assigned to either human or robot assets. Assignment and scheduling of robot-assigned tasks will be discussed in greater detail below.

Task management system 706 may provide the creation, assignment, and monitoring of tasks within a facility. Tasks may be human-assigned or robot-assigned. Task management system 706 may include, for example, a collaborative information server 722, which may support sharing information between operation task management system 706 and other subsystems of operations management system 700. Task management system 706 may also include a trigger management module 725, which may generate new tasks triggered by incoming information, and a task execution management module 726, which may control the assignment and execution of tasks. Management of robot-assigned tasks will be discussed in greater detail below.

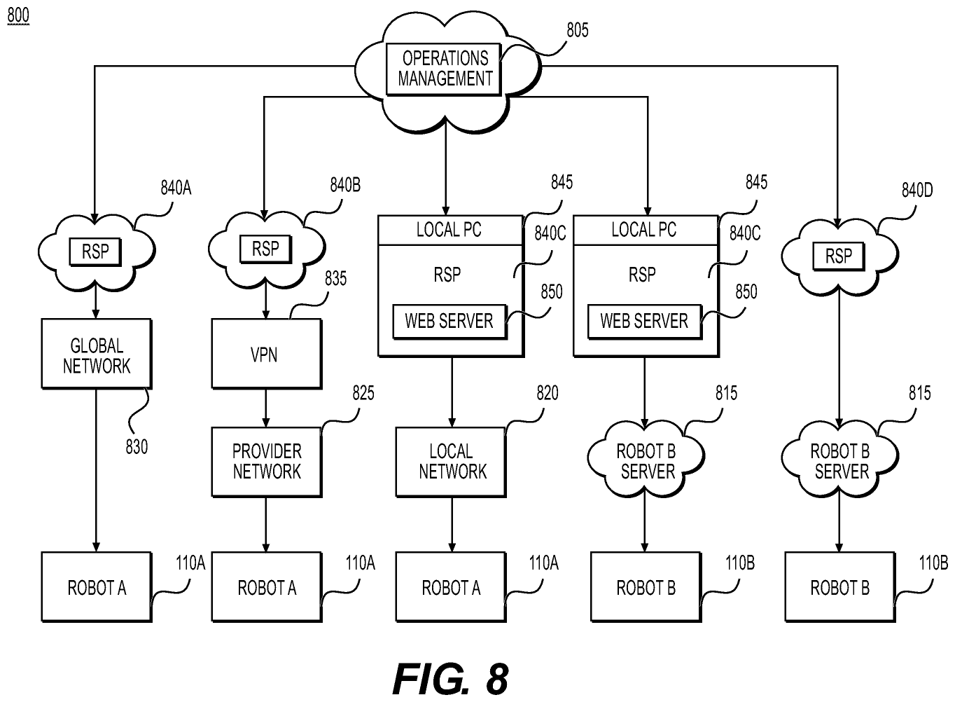

RSP 672 may provide management and operation of a fleet of robots of varying types provided by multiple vendors. RSP 672 may include, for example, a collaborative information server 722, which may support sharing information between RSP 672 and other subsystems of operations management system 700. RSP 672 may also include robot fleet management module 628, robot data management module 640, robot common interface module such as robot-specific adapters 644, database 620, a robot data analysis module such as data management module 640 and machine learning (ML) and artificial intelligence (Al) module 642, all of which are discussed above with respect to FIG. 6. RSP 672 may further include, for example, robot interface modules specific to different types of robots, such as robot A interface 742 interacting with robot 110A of type A, robot B interface 744 interacting with robot 110B of type B, and robot C interface 746 interacting with robot 110C of type C. Robot interfaces may connect directly with robots 110, such as is shown for robot B interface 744 and robot C interface 746, or may connect to a robot 110 through an external robot controller, such as robot control 748 connecting robot A interface 742 with robot 110A. Such external robot controllers may be cloud-based servers, as shown in FIG. 7, or may be connected by various types of computer networks. Exemplary connections between a robot support platform and robots 110 will be discussed below with respect to FIG. 8.

FIG. 8 depicts an environment 800 for robot control and communication within a multivendor robotic services platform, according to one or more embodiments.

Operations management system 805 may include many systems and modules for the overall management of an industrial facility, such as, for example, those systems and modules depicted in FIG. 2 and discussed above. As discussed above, operations management system 805 may interact with a robot support platform (RSP) 840 to provide information for missions and tasks related to the operation of the plant that may be performed by robots, such as robots 110A and 110B.

Connection between operations management system 805, RSP 840, and robots 110 may be provided differently depending of the needs and capabilities of the facility and robots 110. For example, in one embodiment, RSP 840A may be provided as a cloud-based service which utilizes a global network 830, such as the Internet, to connect to robot 110A. In another embodiment, a cloud-based RSP 840B may use a virtual private network 835 to securely connect to an internet service provider network 825, and from there connect to robot 110A. In yet another embodiment, RSP 840C may be provided as an application running on a local computer, such as local personal computer 845. RSP 840C may utilize a local webserver 845 and a local network 820 to connect to robot 110A. In yet another embodiment, RSP 840C may utilize webserver 850 to connect to a vendor-specific robot server 815 and from there to robot 110B. Vendor-specific robot server 815 is depicted as a cloud-based service, but vendor-specific robot server 815 could be provided, for example, on local personal computer 845, on a different local computer, or on a remote computer accessible via a global network, such as the internet, etc. In another embodiment, cloud-based RSP 840D may connect to a vendor-specific robot server 815 and from there to robot 110B.

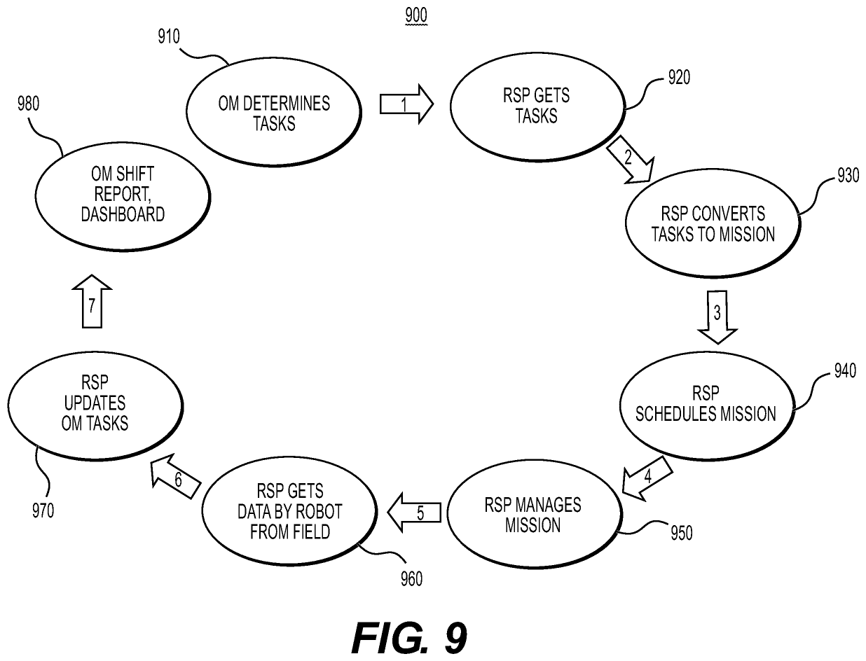

FIG. 9 depicts a process 900 of assigning, scheduling, and executing robotic tasks within a multivendor robotic services platform (RSP) (e.g., RSP 672 in FIG. 6), according to one or more embodiments. In operation 910, an operations management system (OM) (e.g., OM 700 in FIG. 7) may determine that one or more tasks for the operation or maintenance of an industrial facility are desired to be undertaken. At least one of the tasks may be designated for completion by a robot, in operation 910 or later in the process by an RSP. In operation 920, the OM may transmit the robot-designated tasks to an RSP. In operation 930, the RSP may convert the received robot-designated tasks into one or more robot missions. Converting a received robot-designated task into a robot mission may include determining factors of the mission, data related to an environment in which the task is located, and/or mission capabilities for accomplishing the task, as described herein. Defining a robot mission will be discussed in greater detail below. In operation 940, the RSP may schedule the one or more robot missions to include, for example, selecting a suitable robot, or robots, and assigning the mission to the selected robot(s). Selection and assignment of robots to particular tasks will be discussed in greater detail below. In operation 950, the RSP may manage (e.g., initiate, monitor, and otherwise manage) the one or more robot missions. Managing a robot mission may include, for example, dispatching the robot, monitoring the robot's progress during the mission, and responding to events during the mission, such as by assigning additional or replacement robots to the mission. Managing a robot mission will be discussed in greater detail below. In operation 960, the RSP may receive data generated by the one or more robot missions. Processing data resulting from robot missions and/or other feedback received from the facility before, during, or after a mission will be discussed in greater detail below. In operation 970, the RSP may update the tasks received from the OM based on the received data. In operation 980, the OM may update various information about the operation of the facility and the completed tasks. This information may include plant operating and maintenance status, and may displayed through various user interfaces, such as, for example, a shift report or a facility status dashboard. The OM may also use the completion status of the tasks and the data generated by the tasks to plan future tasks in a new iteration beginning with operation 910.

Methods of Defining, Assigning, and Managing Missions

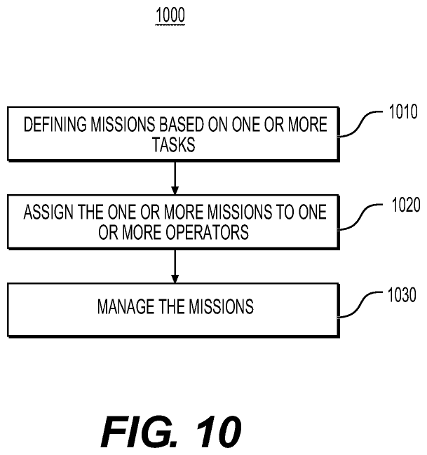

FIG. 10 illustrates a flowchart 1000 for defining, assigning, and managing one or more missions, e.g., in industrial setting facility 100 shown in FIG. 1. For example, in Step 1010, one or more missions may be defined based on one or more tasks, and factors or criteria for achieving each task. The missions may be defined by an operation management system, e.g., operation management system 700 in FIG. 7, a user, e.g., via control system process control client 604, web client 606, or directly via an input device, another system in communication with RSP 672, or RSP 672. Once the one or more missions have been defined, the missions may be assigned to a human, a robot, or a combination of humans and robots in Step 1020. As will be described herein, missions may be scheduled and assigned via robot fleet manager 628 of RSP 672. The missions may be continuously or intermittently monitored by RSP 672, and the missions may be managed, e.g., altered, based on feedback from the human and/or robot operators while the missions are monitored, in Step 1030. Examples of defining, assigning, and managing missions are described herein.

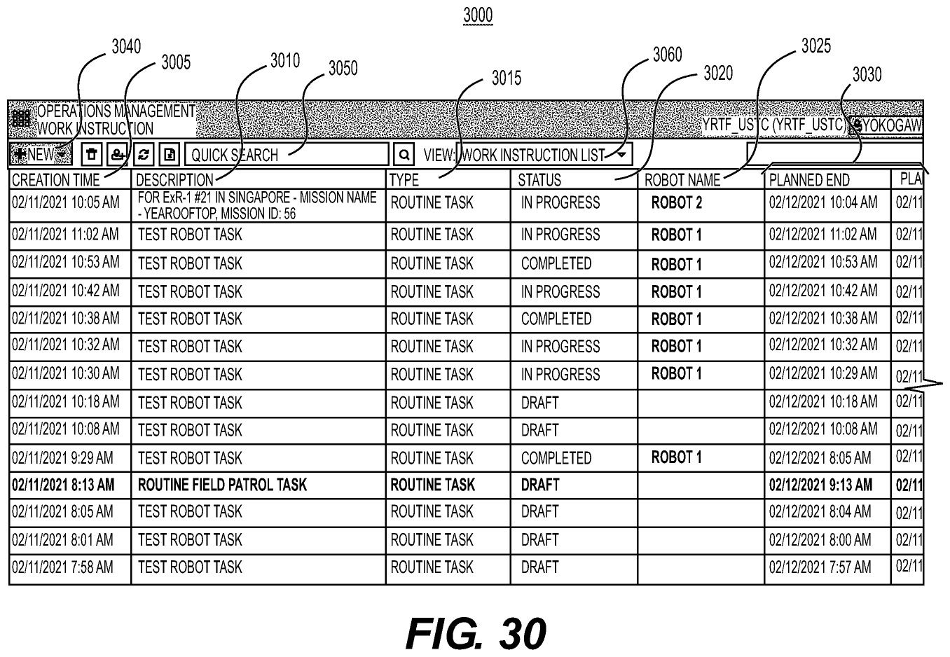

According to an example, one or more missions may be defined by the robot management system RSP 672 in FIG. 6. The one or more missions may define one or more tasks to be completed by an operator, e.g., a human operator, a robot operator, or a combination of human and robot operators. For example, to define a mission, one or more tasks may be selected or input manually, e.g., by a user via a dashboard 3000 in FIG. 30, or automatically, e.g., via process control client 604 or via a remote site, first or second web clients 634, 636. A task may include the purpose of the mission, in other words, the ultimate duty to be performed in a mission. As examples, a task may include monitoring and/or obtaining a data point, status, or condition of an environment, machine, or facility (e.g., pressure, temperature, humidity, other weather condition, noise level and/or type, vibration, a sensor value, location, a level of a substance (e.g., fuel, gas, fluid, etc.), altitude, weight, obtaining a sample (soil, air, a product of a machine or facility, etc.), battery level, etc.), performing all or part of an operation at or within a machine or facility (e.g., flipping a switch, pressing a button, moving an item, turning a valve, performing a step in assembly of an item (e.g. within an assembly line or otherwise), adjusting a workpiece or other item, fixing a broken workpiece or other item (e.g., tapping a gauge to provide a proper reading), lifting an item, performing maintenance on an item (e.g., replacing a circuit board or other part of a device), etc.), and/or any other duty necessary or desirable within a facility.

While a mission may include a single task, the mission may include a plurality of tasks performed together. The multiple tasks may be performed concurrently and/or may be performed consecutively. In some instances, one task may necessarily be performed before another task. In this instance, the mission may indicate the order of the tasks.

A task may be determined by operations management system 700, RSP 672, or any other system or module in communication with operations management system 700 and/or RSP 672. As described further herein, operations management system 700 and/or RSP 672 may define a mission based on, among other things, factors, data, and mission capabilities (as described further herein) necessary or desirable for completing the task. A mission may include all of the information instructions necessary or desirable to perform a task.

For example, dashboard 3000 (see FIG. 30) may allow a user to enter factors, data, and mission capabilities, as described herein. Dashboard 3000 may include categories to display various information related to missions. For example, creation time 3005 may indicate when a mission was created. Description 3010 may provide details of a mission, or a mission name. Task type 3015 may include the type of task, e.g., a routine task, an ad-hoc task, a maintenance task, an emergency task, or the like. Status 3020 may indicate if the task is in progress, is completed, or if the task has been defined but not yet initiated (e.g., draft). The name and/or type of robot scheduled for the mission may by be indicated under robot name 3025, and a planned end and start time 3030 may indicate when the mission will begin and/or end.

A user may use the new function 3040 to create a new mission, and may input information described herein to define the mission. Alternatively, the data may be automatically populated, e.g., from historian 612 or some other memory. The user may also use search 3050 to search for a task, mission, or other data within dashboard 3000, and/or organize the tasks and/or missions via work instruction list 3060. Work instruction list 3060 may allow the user to access a dropdown menu to select which categories to view, and/or which categories to use to organize dashboard 3000.

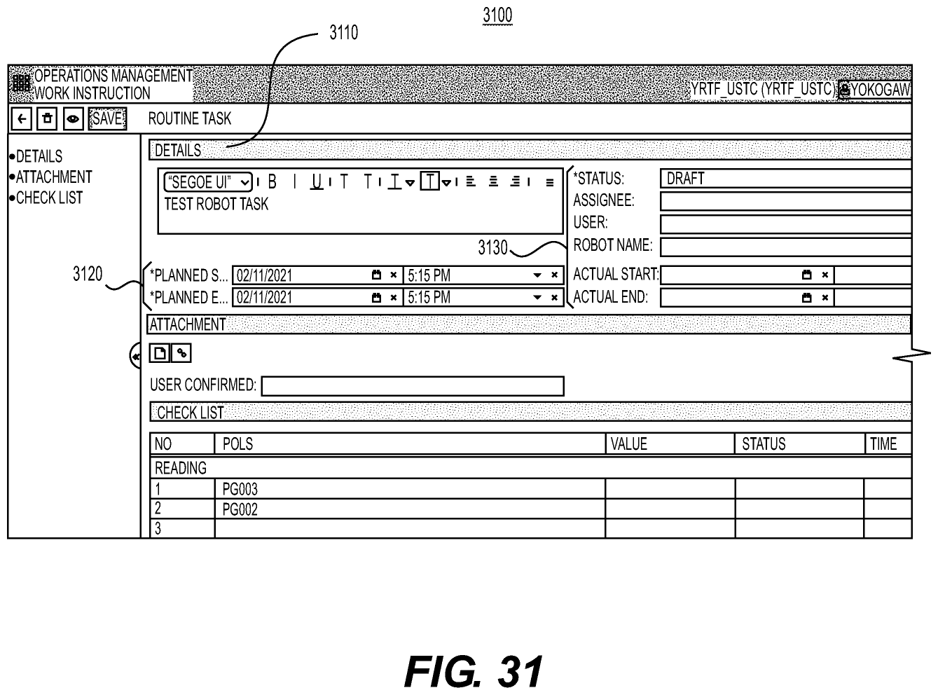

With reference to FIG. 31, a work instruction 3100 (e.g. mission profile) may be created by a user, e.g., via the new function 3040 in FIG. 30. Work instruction 3100 may include various inputs, such as details 3110 of the mission and task, planned start and stop times 3120, and operator status categories 3130. Attachments 3140 may be included in the work instruction 3100. The attachments 3140 may be used by the operators for additional data on the mission, task (e.g. tools to use for the task), or the like. The work instruction 3100 may include various layouts and information and is not limited. Further, this information may be updated and/or confirmed by users or automatically, as described herein.

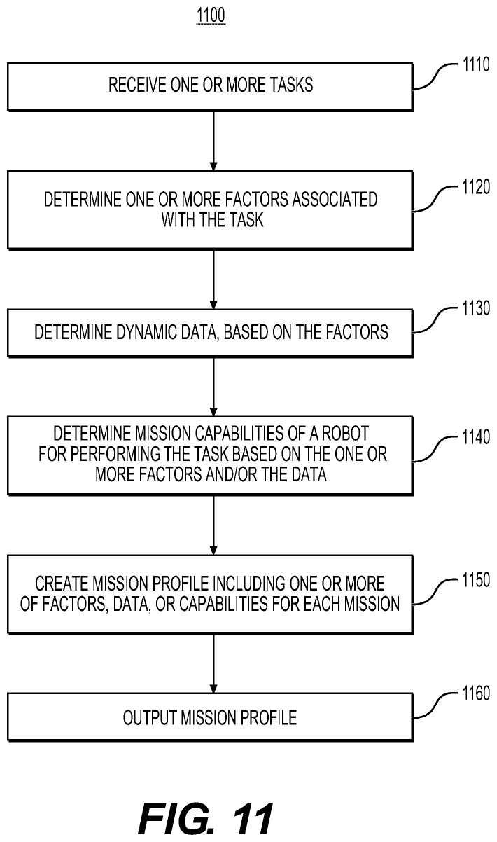

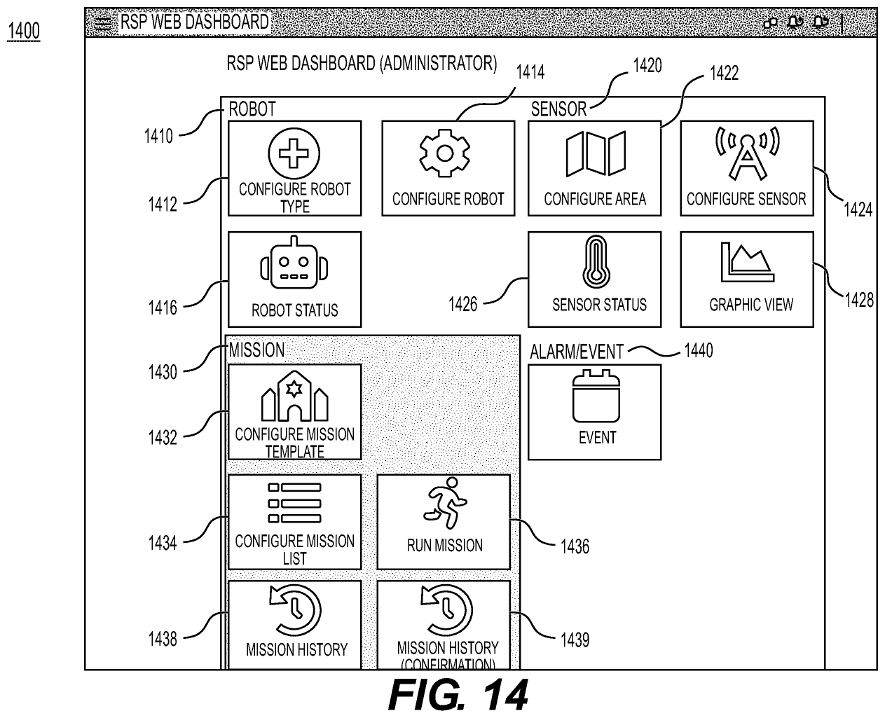

FIG. 11 illustrates a flowchart 1100 for defining a mission. In Step 1110, RSP 672 may receive a task. The task may be received by RSP 672 via process control client 604, via an input directly to RSP 672, e.g., via a user interface (e.g., dashboard 1400 in FIG. 14), via a remote system, e.g., a wired or a wireless device connected to operations management system 700 or RSP 672, via a memory interfaced with operations management system 700 and/or RSP 672, e.g., historian 612 in FIG. 6 storing historical data, or a combination thereof. The task may be sent to RSP 672 in response to a user command, or may be sent automatically, for example based on feedback received by RSP 672 and/or operations management system 700. As a further example, the task may be received based on feedback from one or more operators performing missions and being managed as described herein (e.g., robots 110, and/or human operators).

Upon receipt of the task, factors that may be used to define the mission may be determined in Step 1120. Such factors may include information necessary or useful for performance of the task. For example, if the task is to obtain a sensor reading, factors may include, but are not limited to, the following sensor information: type (analog, digital, etc.), location, altitude, map of area surrounding and leading to the sensor (information sufficient to gain access to the sensor), environmental conditions at the sensor location (e.g. temperature, pressure, etc.), etc. Another factor may include timing of the task, e.g., when the task must begin and/or when the task must be completed. Additional factors may include steps that may, or must, be accomplished to complete the task. For example, again referring to obtaining a sensor reading as the task, it may be necessary for a switch to be activated prior to obtaining the sensor reading. In this instance, the factor may include the step of activating the switch prior to reading the sensor. Other steps (factors) may include opening a door, climbing stairs, passing through a tunnel, turning on a light, etc.

Factors may also include routes to the sensor, and factors within those routes. For example, factors may indicate whether there are low hanging objects along the route, indicate whether there is an opening to navigate, and/or include dimensions of one or more passages along the route. For example, a factor may include a smallest opening along a route. The factors also may include various routes for accessing a task location. For example, a map may provide a plurality of possible routes for accessing the task location, regardless of how an operator would access the location. For each possible route, factors associated with the route, e.g., dimensions of passages of the route and/or objects along the route, may be included in the factors.

In Step 1130, dynamic data (e.g. data that changes over time) may be received based on the one or more factors. Such dynamic data may include specific values or parameters necessary or useful for performance of the task, based on one or more factors. For example, again referring to obtaining a sensor reading as the task, if a factor is location, and the sensor is movable, data regarding the sensor's location may be needed. That data may be obtained by any suitable location means, such as GPS, cameras, etc. If the sensor is fixed (immovable), additional information regarding the location may not be necessary, as this information will be included as a factor. As another example, if temperature is a factor, a value (data) for the temperature may be obtained, for example via a thermometer adjacent the sensor.

Dynamic data may also be managed through operations management system 700. For example, sensor profiles may be updated by operators with data which may be used to run one or more missions. Alternatively, or additionally, the sensor profiles may also be updated automatically using data from other systems, e.g., remote or external systems, or based on feedback from sensors within the facility and/or feedback from other missions. Dynamic data (e.g., weather) may also be obtained and updated by RSP 672 via a third-party, e.g., a weather application. Sensors attached to a robot and/or the sensors in the facility may also provide this dynamic feedback. For example, if a robot senses water, e.g., rain, and the robot is incapable of functioning in rain, the robot may terminate the mission and travel to a predetermined, covered location. The robot (or other communication device) may also communicate the termination of the mission to RSP 672. RSP 672 may reassign the mission to another robot having the capabilities to perform the mission, including the capability to operate in water. Alternatively, RSP 672 may schedule the same robot to complete the mission after the rain has stopped. In some instances, RSP 672 may use the weather data from the third-party and/or other sensors in the facility to terminate the mission if the robot is incapable of determining there is rain, e.g., the robot does not have a sensor and/or an edge processor to detect and/or terminate the mission on its own.

More generally, data may be received from sensors in and around a facility in which RSP 672 manages a fleet of robots. Data may include dynamic measurements or information, such as a location of a movable object in a facility, map information of the facility, and/or other environmental conditions related to the facility. For example, environmental conditions at the task location and/or environmental conditions on the route to the task location may comprise data. Environmental conditions may include an ambient temperature, an air content or an air quality, a condition of one or more surfaces at, or on the route to, the task location, or the like. The environmental conditions may be conditions along a single route to the task location, or may include environmental conditions along multiple routes to the task location.

In certain circumstances, it may be useful to provide additional sensors to supplement or compare with existing sensors, allowing for deeper analysis of the sensor data or for accuracy checks of existing sensors. For example, if existing sensors indicate an anomalous change in data readings, the robot may carry and place a sensor at a location for a temporary data reading. The robot may be instructed to place the sensor by the RSP 672 as described herein, or may autonomously or semi-autonomously decide to do so. This additional sensor may transmit its data reading by wired or wireless connection, and may transmit the data reading to the robot or elsewhere for analysis and/or comparison with a reading from existing sensors.

Data may further include information regarding dynamic (e.g., movable, changeable) objects along the route to the task location. For example, containers, people, or other objects may be located along the route. These objects may be associated with one or more sensors which may indicate when and where the object is moved, or locations may be obtained by other means, such as imaging. In addition, data may indicate expected objects along a route that are no longer present. Alternatively, or additionally, any type of data, such as image data, may be received from one or more of sensors, personnel, or robots as feedback, described herein. The image data, for example, may show when and where objects are moved along the route, and may be included as data in defining a mission profile. The image data, for example, may show information important for human activity in an area, such as the presence or absence of fire extinguishers, the availability of appropriate personal protective equipment (hard hats, safety boots, etc.) on site, etc.

In Step 1140, mission capabilities of an operator for carrying out the mission are determined based on the factors determined in Step 1120 and/or the data received in Step 1130. Mission capabilities may include features of the robot to allow the robot to perform the mission and accomplish the task. For example, if a reading is to be obtained from an analog sensor, it may be necessary to image the sensor. A mission capability therefore would include imaging capability. An additional mission capability may be obtaining a sensor value from the imaged sensor. This may be accomplished, for example, by accessing an image analysis program for determining the sensor reading based on the image. Instead of a mission capability of a robot, the image analysis program may be associated with operations management system 700, RSP 672, and/or a remote system connected to operations management system 700 or RSP 672. For example, image data analysis, as well as other type of analysis of raw data collected by the operator, may be performed by robot data analysis module 642 of RSP 672. In some instances, the mission may require that a certain robot may not be assigned, or may be unassignable, to a mission based on the features of the robot. For example, the mission capabilities may indicate that at least a portion of the mission must be carried out within the dimensions of a given area; the route to the mission may require passing through a small space, or certain tools or tool packages. If the robot is too large to navigate a route to the mission or if the robot is not equipped with a particular tool or tool package, the robot may be designated, e.g., by RSP 672, as unassignable to that mission.

Mission capabilities may include features associated with the robot so that the robot may operate in certain environments. For example, if temperature is a factor, and the data indicates a very high temperature, a mission capability may be an ability of a robot to withstand temperatures at or above a certain temperature. Mission capabilities may also include, for example, an ability to access a location at a certain height. Mission capabilities may also include being able to go down stairs, accessing a confined space of defined dimensions, or otherwise having the ability to traverse a route to the location. Mission capabilities may also include an availability of a robot at a specific time and/or for a specified amount of time, based on a factor defining a start time, end time, and/or a duration of a mission.

Once the factors, data, and/or mission capabilities are determined or received by RSP 672, a mission profile may be created in Step 1150. The mission profile may be a data file including the factors, data, and mission capabilities that define the mission. The data file may be in any format, e.g., a format compatible with operations management system 700, RSP 672, and/or any other system. The data file may be compatible with, or may be modified to be compatible with, one or more robot types, as described above.

In Step 1160, the mission profile may be output directly to a robot or other system for viewing by a human and/or further processing. For example, the mission profile may be output to a device having a display, e.g., a wired or wireless device, such that a user may view the mission profile. The display may include a graphical user interface (GUI) that may display each of the factors, the data, and/or the mission capabilities in the mission profile. The mission profile may also be stored in a memory, e.g., a memory associated with RSP 672 (e.g., to be saved in historian 612 in FIG. 6), with operations management system 700, and/or one or more operators, e.g., a memory associated with a robot or a memory of a device operated by a human. The mission profile may also be modified before or after being output by RSP 672 to be compatible with one or more other systems, e.g., operations management system 700, a robot, or the like.

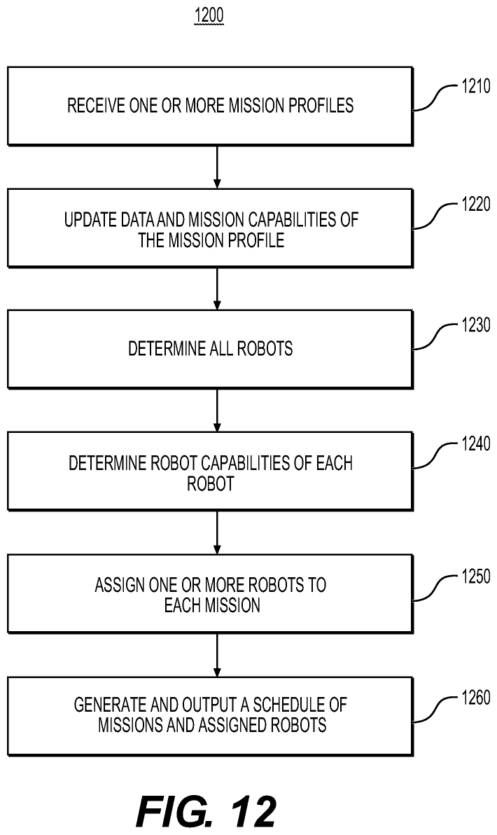

For example, outputting the mission profile may cause RSP 672 system to generate multiple files to be compatible with all of the systems (e.g., robot systems and/or any other systems) associated with RSP 672. Alternatively, or additionally, RSP 672 may query all systems to determine a file format to output the mission profile. For example, as shown in FIG. 6, Robot Type A 110A and Robot Type B 110B may be capable of receiving a mission profile having an unaltered file format. In contrast, Robot Type C 110C may require the mission profile to pass from RSP 672 via fleet client 664 to modify the mission profile file format to be compatible with Robot Type C 110C. As will be described herein, missions may be assigned to robots based on a schedule. Thus, mission profiles may not be provided to the robot until after the missions are assigned, as described in flowchart 1200 of FIG. 12. Alternatively, a mission profile may be transformed from a common internal format to a format suitable for a particular robot or robot type by a robot-specific adapter 644, as discussed above with respect to FIG. 6.

A mission file may contain one or more of the following: a mission identification (e.g., name, number, etc.), a mission priority level, and/or the identification of any other missions that are scheduled to be completed at the same time as the mission; metadata including an author's credentials and/or contact information, profile of the time and date of mission generation, description of the mission, etc.; a make and model of the robot, including the current version of the software being used by the robot, a weight or dimensions of the robot, etc.; payloads currently loaded on the robot and/or payloads that may be used by the robot; fiducials (e.g., barcodes, QR codes, markers) associated with the robot; minimum battery/energy requirements of the robot to complete the mission, and any reserve built-in to account for any diversions by the robot during the mission; a map of the facility (2-dimensional and/or 3-dimensional); routes and/or tasks along the routes for achieving the mission; start and end times, or time ranges for performing the mission; any personnel and/or other robots necessary to complete the task; credentials of operators or other robots capable of starting, stopping, and/or altering the mission; communication protocols; mission-specific and/or general alarms or alerts that may occur during a mission, and instructions for operation if the alarm is tripped; pre-conditions for starting, performing, and/or completing a mission (e.g., not raining during the mission or during at least portions of the mission); sensor location and details of the sensor on both the robot and any sensors with which the robot is configured to interact during the mission; or any optional or secondary missions that may be performed based on feedback received during the mission.

In some examples, mission files may be generated based on the robot type, e.g., based on the manufacturer of the robot or the like. Each robot type may include a certain method of recreating a sequence of actions based on an instruction list. In some instances, a plurality of robots may be designed to recreate a sequence of actions in a similar manner. Each robot may generate a file, e.g., a directory of instruction files, which the robot may transmit to RSP 672 via robot-specific adapter 644. RSP 672 may select the mission file based on the type of robot. As the mission profile is generated, the mission capabilities may inform RSP 672 (or an operator) what functions the robot must be capable of satisfying to perform the mission. For example, as described herein, if the mission includes taking a photo, the mission profile may indicate how many photos to be taken, the resolution of an imager for obtaining the photos, what objects to be photographed, etc. RSP 672 may provide the robot-specific methods to an operator such that the operator may generate the mission profile based on the robot-specific language. If a mission requires multiple robots, the operator may repeat the process of generating the mission profile in the robot-specific language for each robot. Alternatively, RSP 672 may automatically generate the mission profiles. In some instances, a robot language which is generic to the robots may be used such that a single mission profile may be generated using the generic robot language. In some examples, RSP 672 may confirm the capability of the robot prior to assigning the mission to the robot to ensure that the robot capability has not changed. For example, a payload of the robot may have changed or a sensor may be malfunctioning.

Assigning one or more missions is described with reference to flowchart 1200 in FIG. 12. In Step 1210, one or more mission profiles may be received. The mission profile received in Step 1210 may be a mission profile output during Step 1160 in FIG. 11. Alternatively, or additionally, the one or more mission profiles may be received via a user input, e.g., via a wired or wireless device, via a memory, e.g., based on historical data as explained herein (e.g., from historian 612 in FIG. 6), and/or from another system, e.g., a third-party system. As described herein, each mission profile may include one or more tasks, factors necessary or useful for performance of the task, dynamic data based on the one or more factors, and/or mission capabilities of a robot for accomplishing the mission. Missions may be assigned based on the factors of the mission and the robot type.

The capability of a robot to perform a mission, or the capability of a plurality of robots to perform the mission, includes the capabilities of the one or more robots satisfying all features of the mission. Conversely, a robot is incapable of performing a mission if the capabilities of the robot do not satisfy every feature of the mission. As described herein, multiple robots incapable of satisfying all features of the mission alone but capable of satisfying all features of the mission together may be jointly assigned the mission. This decision of whether a robot is capable or incapable of performing the mission may be determined by RSP 672 or the robot. For example, RSP 672 may initially assign the mission to one or more robots based on the features of the mission, but the robot may determine during the mission that it is incapable of performing one or more features of the mission based on feedback, as described herein.

It will be understood that multiple robots may be capable of performing the same mission. In this instance, the mission may be assigned to any of those robots capable of performing the mission. Alternatively, the mission may be assigned to one of the multiple robots based on one or more priorities of the mission. A priority of a mission may be an attribute having a desired level of importance to the mission, in contrast to features of the robot needed to perform the mission and accomplish the mission's task. Priorities can include, for example, one or more of a desired quality of the performance of the mission and its task, a desired efficiency level in performance of the mission/task, a desired cost for completing the mission/task, etc., Each of these mission priorities can have a threshold associated with it, for example a quality threshold or a cost threshold, required for performance of the mission. For example, a mission may be characterized as requiring a highest quality level of mission or task performance, performing the mission or the task in the shortest amount of time, performing the mission or the task using the least amount of energy, performing the mission or the task with the fewest faults or failures or requests for further assistance/human intervention, and/or performing the mission or the task at the lowest cost (e.g., if the robot is used in a leasing arrangement), etc. One or more of the robots may be selected based, at least in part, on these additional criteria. For example, a mission may include designations such as “highly critical,” such that it requires a very high quality output, without failure. In such a situation, a robot having the fewest failures may be selected instead of another robot capable of performing the mission, but having a higher failure rate. As another example, if a priority of the mission includes performing the mission in the most energy-efficient manner, the mission may be assigned to a robot based on, in part, the robot being capable of operating using lower energy.

In some instances, certain mission priorities may not be dispositive when assigning the mission to a robot. In other words, a priority of the mission may be desired but not necessary. In the example given above, the priority may include using lower energy to complete the mission. However, if the only robots capable of performing the mission have high energy usage, the mission may be assigned to one of these high-energy consuming robots regardless of the priority, as the desired energy level may be trumped by the time by which the mission must be accomplished.

It will also be understood that a priority may not be a numerical value. For example, a mission priority may include some threshold value, e.g., perform a mission if the robot's energy usage is below a predetermined threshold value, or the mission priority may include an order or a timing for performing the mission, e.g., perform the mission at a certain point in a series of missions. Once all missions are assigned, one or more mission schedules may be generated based on all possible iterations of assigning the plurality of missions to the robots. A mission schedule may be selected that satisfies as many priorities of the various missions as possible.

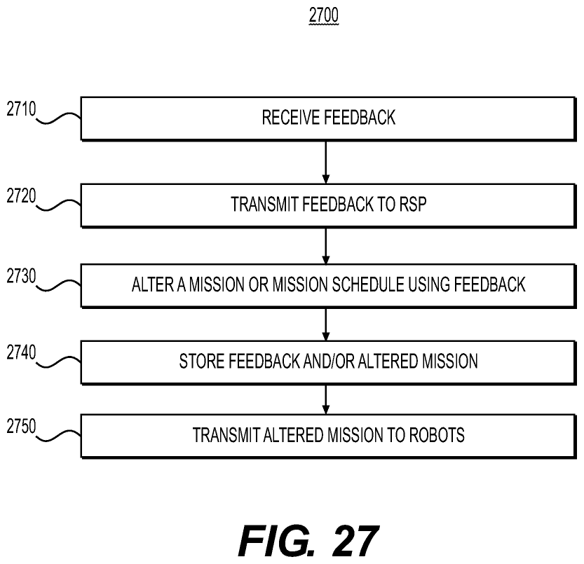

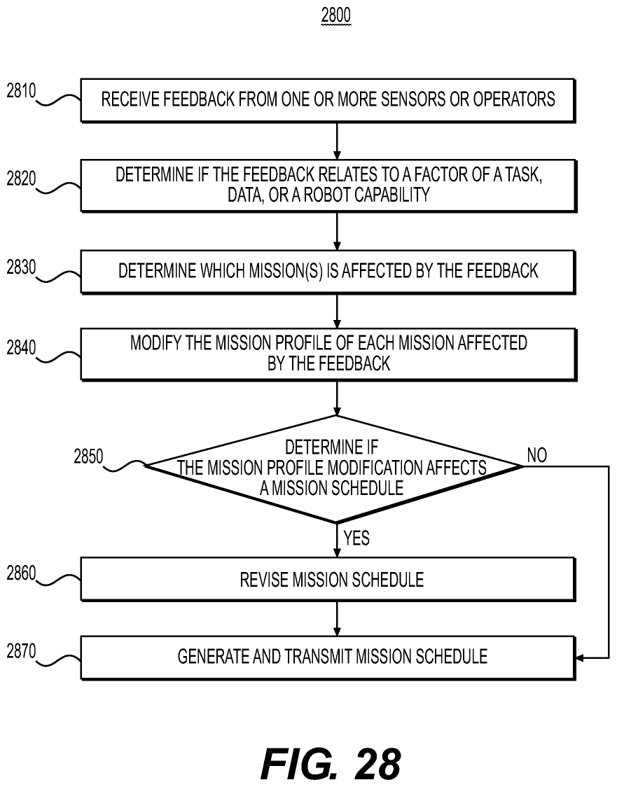

In Step 1220, the data and mission capabilities may be updated, if necessary, based on the passage of time since creation of the mission profile and/or receipt of the mission profile. The factors and mission capabilities may be updated in Step 1220 in a similar manner as outlined in Step 1120. Further, additional information may be available when the mission is being assigned that was not available at the time the mission was determined. For example, data may be modified based on feedback received from sensors and/or operators, as described in flowchart 2700 in FIG. 27 and/or flowchart 2800 in FIG. 28. In this instance, the data may be updated based on the current available information and may ensure that the mission is assigned correctly.

All robots may be determined in Step 1230. This includes any robot at or available to a facility. For example, operations management system 700 may store robots that will be assigned to the facility, or robots that are assigned and may be in maintenance, but are unavailable. This may also include robots that are rented or leased to a facility. Determining all robots in Step 1230 may also include determining all robots in a third party robot fleet. In this instance, any robot determined in Step 1230 may include identifying all potential robots, regardless of availability and/or capabilities. It will be understood that while all robots available to a facility may be identified, not all robots may be capable of being assigned. For example, it may be determined that certain robots are undesirable to be assigned based on high leasing costs, availability based on contract terms, usage costs, or the like.

Once all potential robots are identified, the features and/or capabilities (for ease of understanding, known as “robot capabilities”) of each robot may be determined in Step 1240. Robot capabilities may be received directly from the robot, or may be received from a system storing the robot capabilities. Additionally, or alternatively, robot capabilities may be updated periodically or in real-time based on feedback received from the robot and/or other sensors or inputs. It will be understood that robot capabilities may be at least partially based on additional factors, such as time, location, sequence of operations, etc. (e.g., cameras that operate in daylight may be unavailable for nighttime use, storage of data or physical samples may need to be uploaded or dropped off at a specific location before additional data acquisition may be made, etc.). In some instances, the robot may transmit data to and/or receive data from RSP 672 even when the robot is not performing a mission. RSP 672 may reassign missions, as described herein, based on this data, and/or the robot may receive updates to the mission it is scheduled to perform, or receive additional missions based on this data. Furthermore, real-time monitoring by RSP 672 may determine if a robot is no longer capable of performing one or more missions which are assigned to the robot. For example, a battery level may have decreased beneath an acceptable threshold for performing the mission, and RSP 672 may reassign one or more missions to another robot capable of performing the one or more missions.

Mission capabilities (described above) may be separate and distinct from robot capabilities. While mission capabilities includes features that may achieve the mission, robot capabilities may include features associated with a particular robot. For example, a mission capability may include reading a sensor at an altitude of fifty feet. Robot capabilities that may satisfy this mission capability may include an imager/camera and the ability to fly or scale a side of a building. In addition, while there may be a single robot whose robot capabilities satisfy a set of mission capabilities, it may be possible that two or more robots, each having a separate robot capability, may be needed to accomplish this mission. For example, the mission may require a first robot having a camera and a second robot having rotors and capable of lifting the first robot to the sensor fifty feet off the ground.

Robot capabilities may include an availability of the robot, both generally and/or at a specific time. For example, a robot may be assigned multiple missions, or the robot may be unavailable at a specific time for maintenance or repair, due to low battery, or other conflicts. Robot capabilities may also include information relating to damage to a robot. In this instance, the robot may be operating at less than full capacity, but may be capable of performing some functions. In such cases, the robot capability information may include which nominal capabilities of the robot are unavailable as well as a time by which full capabilities may be restored, if known. Similarly, robot capabilities may include an amount of battery remaining and may indicate how long the robot can be used before it must recharge. Robot capabilities may also include the availability of a human operator to support or monitor certain missions or tasks within a mission (e.g., based on inherently dangerous or critical activities, etc.).

Robot capabilities may also include the abilities of the robot to accomplish various activities, e.g., carry a load over a certain weight, reach a certain height, maneuver through an opening having a specific dimension, rotate or turn an item, take images, sense noise levels and types, grasp an item, apply a force to an item, or the like.

Robot capabilities may also include tools associated with the robot. For example, a robot may have a grasping mechanism that may operate in a manner similar to a human hand for turning a lever or the like. Alternatively, or additionally, the robot capability may include the ability of the robot to acquire and/or to use a tool. For example, a wrench may be available for use by a robot. However, if the robot does not include a grasping mechanism or similar mechanism for holding and operating the wrench, then the wrench may not be a robot capability associated with that specific robot. The robot capability information may further include specifications of tools available to the robot, such as a size or torque capacity of a wrench.

Robot capabilities may also include the abilities of the robot to withstand certain environmental conditions, including certain temperatures, pressures, humidities, etc. For example, a robot may include materials suitable for high temperature applications, but unsuitable for immersion in a fluid. It will be understood that these are examples of robot capabilities, and robot capabilities may include other features associated with the robot. It will also be understood that the condition of the robot (e.g., age, deterioration of certain elements on the robot, etc.) may be included in the robot capabilities.

Once the robot capabilities are determined, one or more robots may be assigned to each mission in Step 1250. The robots may be assigned based a matching of the features, data, and mission capabilities of the missions with the robot capabilities. In this matching step, certain mission capabilities may have more weight than other mission capabilities (be more important in accomplishing the mission), so that robots with robot capabilities matching those more heavily weighted mission capabilities are considered. For example, it may be necessary for a robot to have the robot capability of reaching a high altitude to fix an antenna, but the most preferable robot is unavailable to image or record the fixing of the antenna (a desirable mission capability). Mission capabilities may therefore be weighted or categorized (necessary, desirable, etc.), to optimize the assignment of robots.

Factors other than such matching may influence the assignment of robots to missions. As an example, the robots may be assigned to the missions such that as many missions may be achieved as possible within the timeframe assigned for each mission. If each mission has a time frame in which the mission should be completed, the missions may be assigned such that this time frame factor is satisfied for the greatest number of missions possible. Alternatively, the missions may be assigned such that the missions are achieved to a highest degree, or a threshold degree, of quality possible. For example, if each mission has a quality factor associated with the mission profile, the missions may be assigned to robots in an attempt to have as many missions as possible achieve a predetermined threshold level of a quality metric. The assignment of robots may factor in both quantity and quality of missions accomplished, weighing them both to achieve a suitable assignment of robots. Robots may also be assigned based on the location of the task and/or a distance from a starting point of the robot, a quality of the route to the task, etc. Robots may not be capable of tolerating certain situations, such as sand, wind, temperature and/or temperature differences, presence of water and/or gas, etc., based on the type of robot. In some instances, an alarm may be triggered by the robot and/or by RSP 672 to cause the mission to be interrupted and/or for a different robot (e.g., a “first-responder” robot specially tasked to a certain event) to begin a mission. A mission may be assigned to one or more robots based on the payload of the robot and/or a payload that can be attached to the robot. A mission may also be assigned to one or more robots based on proximity of missions in time and/or space, predicted weather forecasts, priority data, or the like.

Once the missions are assigned, a schedule may be generated and output in Step 1260. For example, the schedule may be output to a device having a display, e.g., a wired or wireless device, such that a user may view the schedule of missions. The display may include a GUI displaying a dashboard (e.g., dashboard 1400 in FIG. FIG. 14) that may display each of the robots and the mission or missions to which each of the robots are assigned. The schedule may also be stored in a memory, e.g., a memory associated with RSP 672, with operations management system 700, one or more robots, and/or any other remote device. The schedule may also be modified before or after being output by RSP 672 to be compatible with one or more other systems, e.g., operations management system 700, a robot, or the like as described in Step 1160 of FIG. 11. For example, outputting the schedule may cause RSP 672 to generate multiple schedule files to be compatible with all of the systems associated with the RSP 672. Alternatively, or additionally, RSP 672 may query all systems to determine a file format to output the mission profile and/or the mission schedule. In this manner, the schedule may be provided to multiple systems and/or multiple robots, which may assist in managing the missions, as will be described herein.

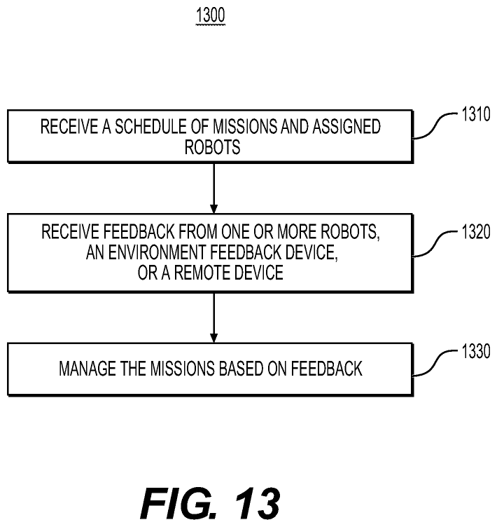

Managing one or more missions may be described with reference to flowchart 1300 in FIG. 13. In Step 1310, a schedule of missions and the robots to which the missions are assigned may be received. The schedule of assigned missions may include the schedule generated and output in Step 1260 of FIG. 12. Alternatively, or additionally, a schedule may be received by, or may be modified by, a user input, e.g., via a wired or wireless device, via a memory, e.g., based on historical data, and/or from another system, e.g., a third-party system. As described herein, the schedule may include the missions and the robots assigned to the missions. The schedule also may include any other information associated with each mission and/or each robot, which may be used in managing the missions. Upon receipt of the mission schedule, missions may be initiated according to the times specified in the schedule.

After the schedule is determined, and/or upon initiation of one or more missions, feedback may be received from the robot, the environment in which the mission and/or the robot is located, or from another remote location in Step 1320. Feedback may be any information sent from the robot to RSP 672 and/or to any other robot, sensor, or other device within, or external to, the system (e.g., the system within facility 100 of FIG. 1). Feedback may include information relating to the overall status of the mission, for example, whether the mission started, when the mission started, and/or if the mission is complete. Feedback may also include any information/data received from a source other than a robot, for example a sensor, including information/data relating to the performance of a mission.

Feedback may include continuous feedback, or may be intermittent feedback based on the communication availability of the robot, human personnel, and/or the facility. For example, the environment of the facility may reduce the ability of communication signals to travel through the environment, and robots or other feedback devices may be capable of communicating only at certain locations throughout a facility. Alternatively, or additionally, data transmissions may be reduced to predetermined timeframes to reduce the amount of data being received and/or transmitted by RSP 672, sensors, robots, other feedback devices, or the like. In some instances, the robots may be instructed to shut down or otherwise stop movement if communication is lost with RSP 672, operations management system 700, or the like. This may be a safety feature which may be useful, e.g., if the robots are not capable of robot-to-robot communication and/or if the robots do not have sensors for detecting the presence of objects along the mission route.

Feedback may also include the status of the robot. This may include the status of the robot performing the mission, and/or may include the status of other robots or personnel that come into contact with the robot. For example, while performing a mission, a first robot performing the mission may encounter a second robot (or personnel) and communicate the status of the second robot to RSP 672. The first robot may communicate the status of the second robot, e.g., stationary, moving, malfunctioning, or the like. This data may be used to alter missions and/or the mission schedule, as described herein. Alternatively, or additionally, the first robot may provide instructions to the second robot from RSP 672. For example, the second robot may be in a location that is unable to communicate with RSP 672. In some examples, RSP 672 may transmit instructions to all robots to provide instructions to the second robot if and when any robot comes into contact with the second robot. In this instance, when the first robot (or any other robot or transmission device) makes communication contact with the second robot, instructions from RSP 672 may be transmitted to the second robot. Similarly, the first robot may receive information from the second robot to transmit to RSP 672, or another device, and the first robot may transmit this information when it makes communication contact with that device. In this manner, all robots may act as communication nodes throughout the facility, which may improve the functionality of the management system and/or the missions scheduled within the system.

Feedback may also include changes in status to an environment and/or information from sensors along a mission route. For example, a robot may determine a smell, hear a noise, sense a vibration, or become aware of an alert from a sensor at a location along the mission route. This feedback may be supplied to RSP 672, may be transmitted to another robot, may cause other missions to be defined, and/or an action may be undertaken by the robot sensing the alert, as will be described herein.

Additional details on the use of feedback are included herein with respect to flowcharts 2700 and 2800 of FIGS. 27 and 28.

In Step 1330, RSP 672 may manage the missions based on received feedback. Management of the missions may include modifying the schedule or a mission based on the feedback. Schedule or mission modification may include a continuous loop, such that the schedule or mission may be continuously modified (including termination) based on feedback from the robots, changes to missions within the schedule, and/or the additions or subtractions of missions to the schedule. In this example, the schedule may be continuously modified. Alternatively, modifying the schedule and missions may include terminating the schedule (or mission) once all scheduled missions (or the particular mission) is completed. Rescheduling or reassigning missions based on a feedback, which may include new missions, is explained with reference to FIG. 27.

Exemplary GUI/Method for Defining, Assigning, and Managing Missions

In some examples, a user may define, assign, and/or manage tasks via inputs directly to a wired or wireless device, e.g., via a dashboard. An example of a dashboard 1400 is shown with reference to FIG. 14. A user may select or modify a mission, a robot, and/or a mission schedule via a graphical user interface (GUI), such as the dashboard 1400. Dashboard 1400 or similar device may allow a user to input commands remotely, e.g., via a web client 606 in FIG. 6, or directly, e.g., via process control client 604. Dashboard 1400 may display various headings, such as robot 1410, sensor 1420, mission 1430, and/or alarm/event 1440. These headings may indicate subcategories that may be selected via a touch, a mouse, or the like for receiving, transmitting, and/or viewing information related to a mission and/or to other events within a facility. The categories and/or subcategories may include an image, a number, and/or a word indicating each category or subcategory. For example, the user may select the subcategory configure robot type 1412, selection of which may bring the user to another screen that lists all available robot types. The user may select the type of robot to be used for a specific mission, or the robot may be selected automatically based on a mission profile, as described herein. Alternatively, or additionally, configure robot type 1412 may allow a user to select a human personnel for performing the mission.

Configure robot 1414 may also be shown under category 1410. Selection of configure robot 1414 may allow a user to select various functionalities or capabilities of the robot, such as including a certain sensor package. Configure robot 1414 may also allow the user to select a package, e.g., certain tools and/or sensors, for a human personnel to use during a mission. It will be understood that the functionalities or capabilities may be automatically selected based on, e.g., a mission profile described herein.

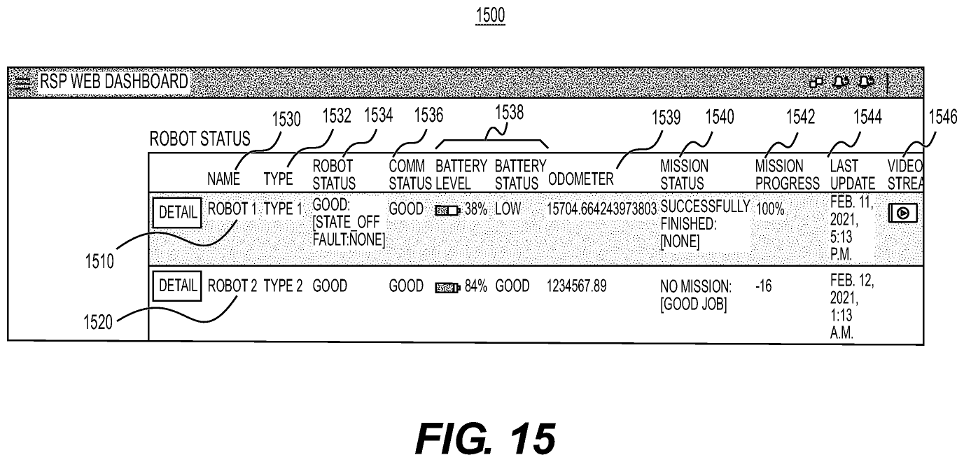

A third category, robot status 1416, may be shown under category 1410. Robot status 1416 may show the status of the robot, e.g., via a list 1500 shown in FIG. 15. For example, a first robot 1510 and a second robot 1520 may be shown in a list format on the dashboard 1400 when robot status 1416 is selected. Robot status 1416 may show various robot capabilities or other information relating to each robot, such as robot name 1530, robot type 1532, robot status 1534, communication (comm) status 1536, battery level and battery status 1538, odometer reading 1539, mission status 1540, mission progress 1542, the most recent (or last) communication update with the robot 1544, and/or whether the robot has a video capability 1546. It will be understood that this list is only an example, and any robot capability or other information relating to a robot may be shown in FIG. 15. It will also be understood that robot status 1516 is not limited to robots, and may be used to show the capability or status of any operator, e.g., a robot or a human personnel.

With continued reference to FIG. 14, four subcategories may be displayed under the sensor 1420 category. For example, subcategories configure area 1422, configure sensor 1424, sensor status 1426, and graphic view 1428 may be displayed. Selecting each of these subcategories may change the display to show various information. For example, selecting configure area 1422 may configure the sensor based on the location in which the sensor is located, e.g., zeroing a sensor for use in a particular area. This may be done manually, or automatically based on feedback. Similarly, selecting configure sensor 1424 may configure the sensor. For example, the sensor may be an imaging sensor, and capabilities of the image sensor, such as brightness, saturation, or the like, may be altered automatically, or manually by a user, when configured sensor 1426 is selected. Selecting sensor status 1426 may provide a status of the sensor, similar to viewing the status of a robot when robot status 1416 is selected. For example, a list of one or more sensors may be shown, and the status or capabilities of those sensors may be displayed when sensor status 1426 is selected. Selecting graphic view 1428 may display the sensors as graphics, e.g., a temperature sensor as a thermometer, a pressure sensor as a pressure gauge, or the like. Selecting graphic view 1428 may also display other information of one or more sensors in graphical form.

Under the category titled mission 1430, a user may select any one of configure mission template 1432, configure mission list 1434, run mission 1436, mission history 1438, or mission history (confirmation) 1439. Selecting configure mission template 1432 may allow a user to change the factors, data, and/or mission capabilities that will be associated with a mission, or may change how the factors are displayed. For example, it may be important for environmental temperature to be considered when defining a mission. In this case, the user may select configure mission template 1432 and may modify the mission template to include temperature as a factor when defining a mission.

Selecting configure mission list 1434 may allow a user to manually modify a scheduled mission or missions. For example, a list of missions and the robot to which each mission is assigned may be displayed when configure mission list 1434 is selected. The user may view the robots and the missions, and may alter the mission schedule. For example, a mission may include acquiring the reading of a sensor, and the user may have knowledge that the sensor is located at a certain height. The user may see the mission scheduled to a robot that does not have the ability to reach the height of the sensor to acquire the sensor data. As will be described herein, this data may be saved for future use, and the mission profile may be automatically updated when data is acquired from this sensor in the future.

Selecting run mission 1436 may cause the mission to begin, or may cause the mission to be scheduled, e.g., to begin at a specific date and time in the future. In addition, if the mission is scheduled in the future, the mission may be manually or automatically selected to begin early via run mission 1436 based a feedback. Selecting mission history 1438 may allow a user to display which missions have been initiated, what data has been acquired, and any alerts or other feedback from the missions. Selecting mission history (confirmation) 1439 may allow data to be manually or automatically confirmed. For example, in the event an image of an analog sensor is acquired, it may be necessary to confirm the reading of the sensor.

The use of dashboard 1400 may allow a user to define, assign, and/or manage missions in any manner described herein. It will be understood that some or all aspects of the defining, assigning, and/or managing of missions may be done manually or automatically. Dashboard 1400 may also enable a user to confirm or correct any data received by the system. Alternatively, dashboard 1400 may be used only to view the status of all missions by a supervisor.

Assigning Missions Based on Priority

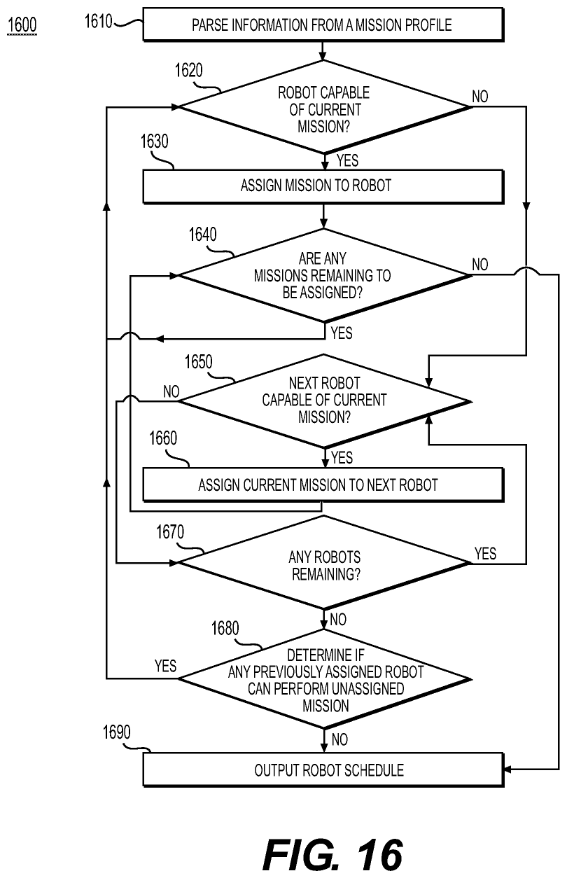

Missions may be automatically assigned in Step 1240 of flowchart 1200 in FIG. 12 based on multiple factors. For example, an assignment of missions is described with reference to flowchart 1600 in FIG. 16. According to one method, RSP 672 may order a set of missions into an order based on a desired priority. As described herein, the desired priority may be based on a relative importance of the missions, a timing of the missions, a cost of missions, a desired quality needed for the task(s) of each mission, etc. The order of missions may consider more than one priority. In Step 1610, factors, data, and mission capabilities may be parsed form the mission profiles. Then, in one exemplary method, each of the robots in a fleet may be evaluated one at a time. For example, robot capabilities of a first robot may be compared to the factors, data, and mission capabilities parsed from the first mission profile in Step 1620. In the event of a sufficient match between the robot capabilities and the factors, data, and mission capabilities, then the first mission may be assigned to the first robot in Step 1630. If there is a sufficient match with the first robot, then, in Step 1640, it may be determined if all missions have been assigned. If there are any missions remaining to be assigned, the flowchart 1600 flows back to Step 1620 until all missions are assigned or it is determined that not all missions can be assigned (as discussed below).

In the event of an insufficient match, a next robot in the queue, e.g. a second robot, may be compared to in Step 1650 to determine if there is a sufficient match. If so, the mission may be assigned to the second robot, and flowchart 1600 circles back to Step 1640 to determine if any missions remain to be assigned. If the determination in Step 1650 is no, flowchart 1600 flows to Step 1670 to determine if any robots are remaining. If there are robots remaining to be searched, all robots are searched to determine if the mission may be accomplished by any of the robots. Each robot may be evaluated until the mission is assigned, or no robots remain.

In the event the second mission is not able to be assigned to a robot, a robot that was previously assigned to a prior mission (e.g., the first mission) may be evaluated in Step 1680. If the second mission is capable of being assigned to the robot assigned to the first mission, the second mission may be assigned to that first robot, and the process may loop back to Step 1620. If the second mission is not capable of being assigned to a previously assigned robot, then the mission is left unassigned. If multiple missions are assigned to a single robot, the method can select from any of a number of options, including leaving multiple missions for a single robot and scheduling them at different times, or determining if any other unassigned robot is capable of accomplishing one of the assigned missions.

Once all missions have been evaluated, a schedule of missions assigned to robots may be determined. In Step 1698, a robot schedule may be output, e.g., as described with reference to Step 1260 in flowchart 1200 of FIG. 12.

Exemplary Methods of Managing A Robot Fleet

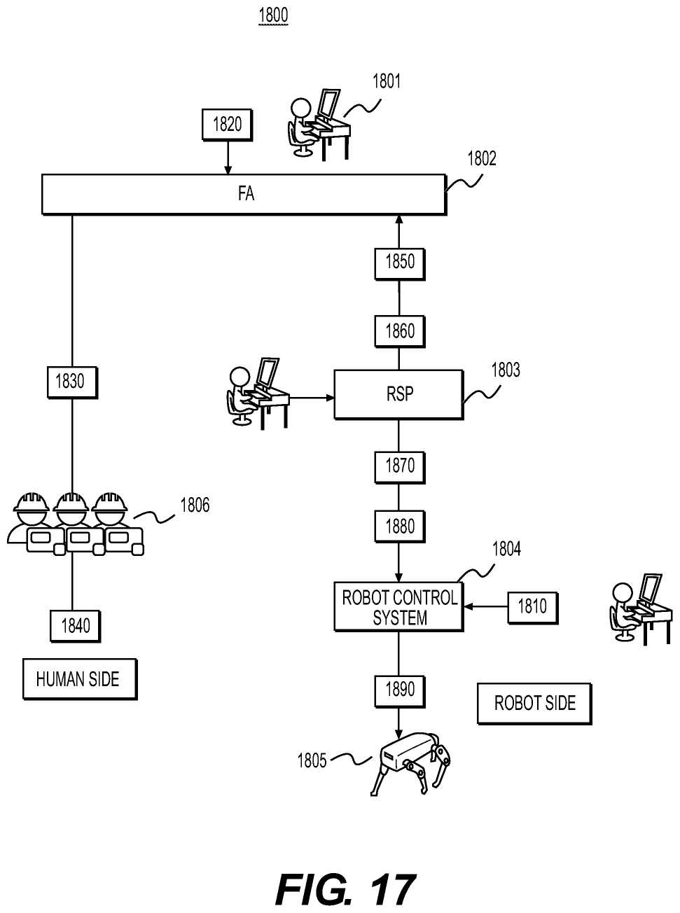

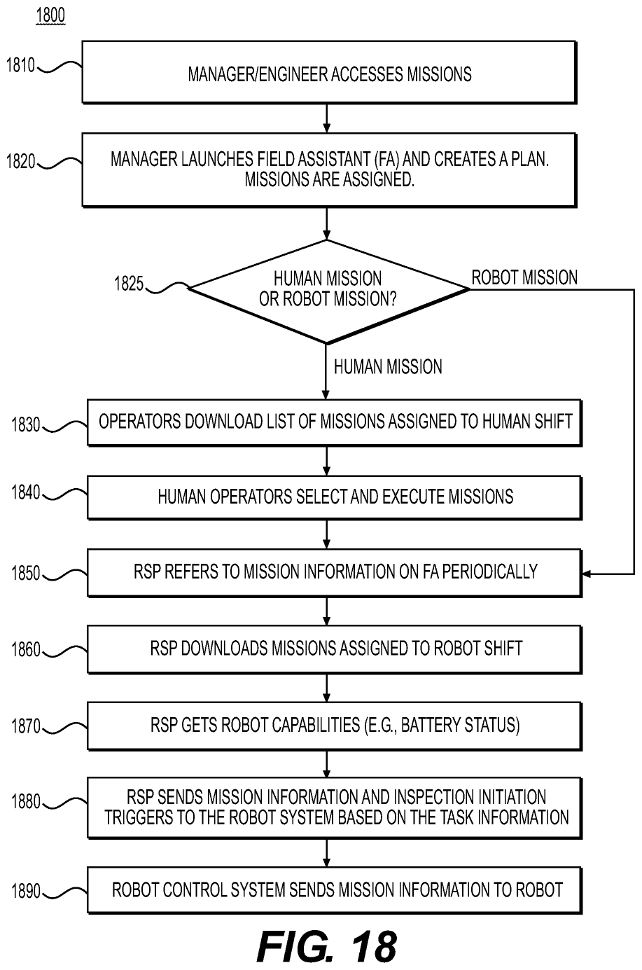

With reference to flowchart 1800 in FIG. 18, an example of defining, assigning, and managing a daily shift is shown with reference to FIG. 17. For example, as an alternative to a completely automated assignment of missions to robots, as discussed above, a manager 1801 or other personnel may assist in assigning one or more missions to robots and/or human operators. This may be done wirelessly or via a wired connection. For example, the robot may include a GUI or keypad for entering data, the robot may include one or more data ports for receiving wired transmissions, and/or the robot may receive data via a wireless communication.

In Step 1810, manager 1810 may access a plurality of missions. The manager 1801 may subsequently launch a Field Assistant (FA) program/module 1802 to create a plan of missions, for set of missions to inspect a facility.

In Step 1825, the manager may first determine if the mission is appropriate for a human or a robot. Any of the steps described above with reference to FIGS. 12 and/or 16 may be used by the manager in this determination. The manager may do that with the assistance of a computer program or algorithm.

If it is determined that the task is appropriate for a human, flowchart 1800 may proceed to Step 1830. Human operators 1806 may download a list of missions that are assigned to the human operators 1806. For example, the human operators 1806 may have access to portable devices that display the missions. Once the missions are downloaded, the human operators 1806 may select and execute the missions in Step 1840. The portable devices may accompany the human operators 1806 while performing the missions. In this manner, the human operators 1806 may provide real-time or intermittent feedback to an RSP 1803 (e.g., RSP 672 in FIG. 6) based on the executed missions. The human operators 1806 may also provide additional feedback, e.g., based on his or her five senses or based on other sensors available to the human operator. As described herein, this feedback may be used to automatically update future mission profiles and/or reassign robots scheduled to execute other missions.

In the event Step 1825 determines that the task is a robot task, flowchart 1800 proceeds to Step 1850. In Step 1850, RSP 672 periodically refers to mission information on the FA 1802 to determine which tasks have been assigned to the robots. In some instances, RSP 1803 may continuously query the FA 1802, or RSP 1803 may be scheduled to query the FA 1802 at specific intervals. Alternatively, the FA 1802 may push tasks to RSP 1803 when the task is scheduled to begin.

Once the mission information is relayed to RSP 1803, missions assigned to the robot during the shift may be downloaded from RSP 1803 to the robot 1805 in Step 1860. The missions may include mission profiles having any information described herein, e.g., factors, data, and/or mission capabilities.

In Step 1870, RSP 1803 may receive robot capabilities from the robot or other system. The robot capabilities may include any such robot capabilities discussed in this disclosure. For example, the mission capabilities may include the status of the robot 1805, e.g., all systems functioning, a battery level, a tool package associated with the robot, and any other information. In response to this information, RSP 1803 may send mission information, such as certain triggers for executing a mission and/or other information to a robot control system 1804 (e.g., such as robot fleet management 480 in FIG. 4).

In Step 1890, the robot control system 1804 may send mission information to the robot. This information may be transmitted wirelessly via communication nodes throughout a facility or via a wired connection, e.g., via a data port in the robot. In this instance, RSP 1803 may control a robot to perform a mission via the robot control system 1804.

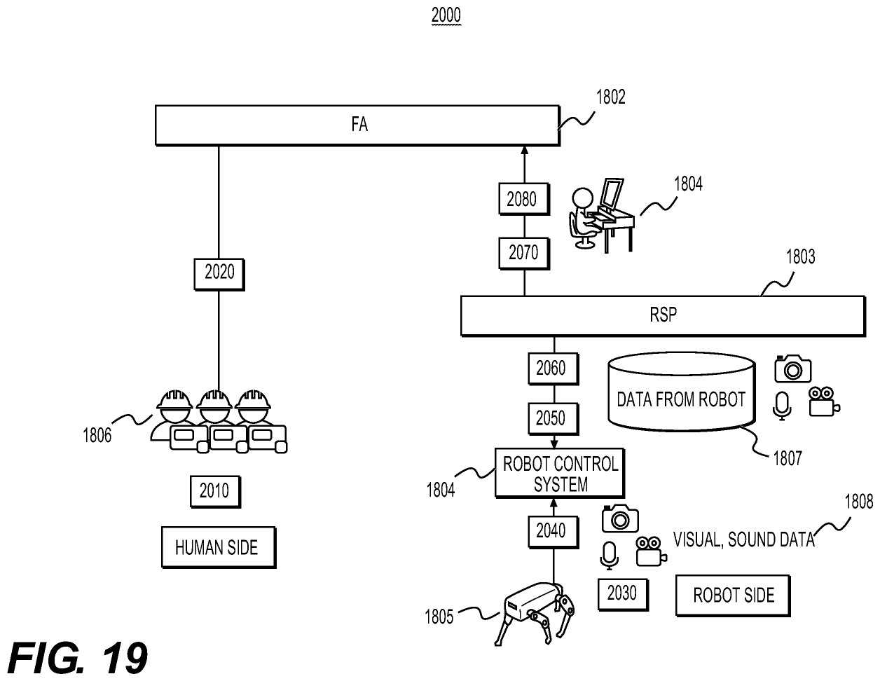

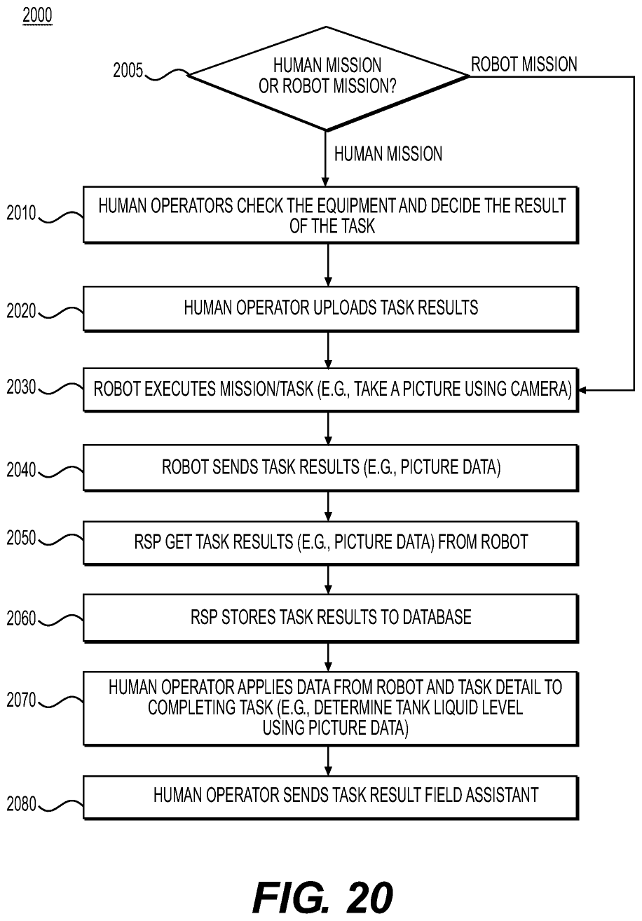

With reference to flowchart 2000 in FIG. 20, an example of assigning and managing missions is shown with reference to FIG. 19. For example, in Step 2005, a human manager or an automated system (e.g., RSP 672) determines if a mission is tasked for a robot 1805 or a human 1806. This determination may be made based on the mission profile, or may be made based on historical data. For example, the mission profile may indicate one or more mission capabilities to complete the mission that may be satisfied by capabilities of a human.

If the mission is designated as a mission for a human 1806, the human 1806 may be tasked with ensuring that he or she has the correct tool package or other needed equipment in Step 2010, including any sensor and/or other tools for executing the mission. Further, the human 1806 then may execute the mission and determine the result of the mission's task. Once the mission is completed, the human 1806 may upload the results of the task to RSP 1803 (e.g., RSP 672), operations management system 700, or another remote system.

If the mission is a mission assigned to a robot 1805, the robot 1805 may execute the mission based on the mission profile in Step 2030. For example, the robot may parse information from the mission profile, including factors, data, and/or mission capabilities associated with the mission, such as whether a sensor should be imaged, a valve should be thrown, or the like.

After the robot 1805 executes the mission, the robot may transmit the results of the mission's task in Step 2040 to a robot control system 1804. For example, the robot 1805 may transmit image data with information relating to a sensor reading, or information confirming that a valve was thrown. This information may be sent wirelessly from the task location, or may be sent via a wired connection when the robot 1805 returns to home base.

RSP 1803 may store any information, e.g. task results, in a database 1807 in Step 2060. It will be understood that any information transmitted by the robot 1805 may be considered feedback, such as visual or sound information 1808, and may be used to define future missions (e.g. factors or data for future missions). The information received during Step 2060 may also be used to determine whether additional missions should be scheduled, and the scope of those missions.

In Step 2070, a manager 1801 may review the data transmitted by the robot 1805 in Step 2050 and may confirm the results. For example, the manager 1801 may review an image of a sensor and confirm the reading was correctly parsed from the image. Alternatively, or additionally, the manager 1801 may perform additional steps with the data, e.g., enter the data in a database or transmit the data to another system. For example, in Step 2080, the manager 1801 may send the result of the task to a Field Assistant (FA) 1802, which may allow a user to view the results, and/or may provide feedback for modifying and/or creating new missions.

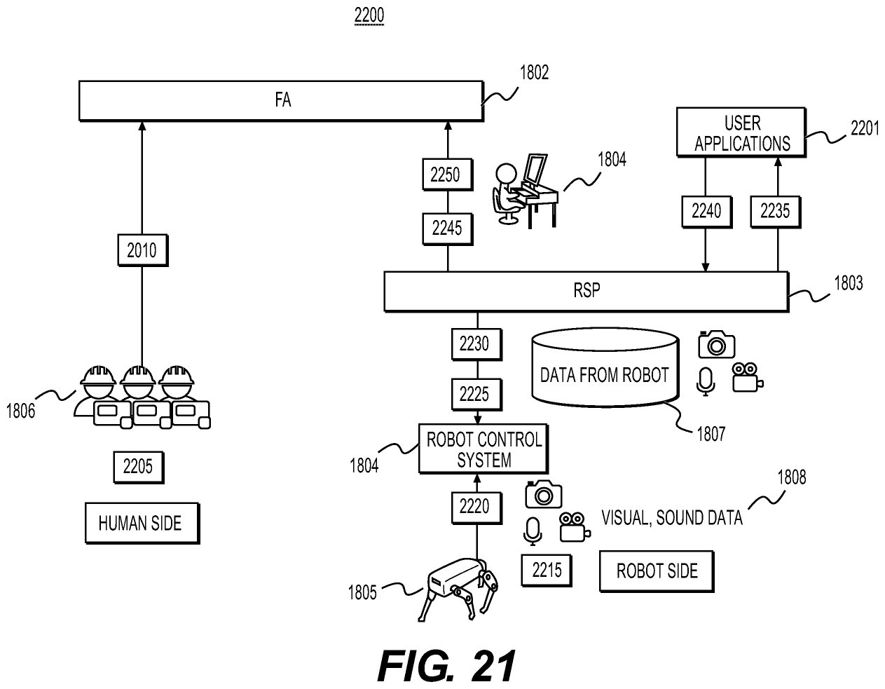

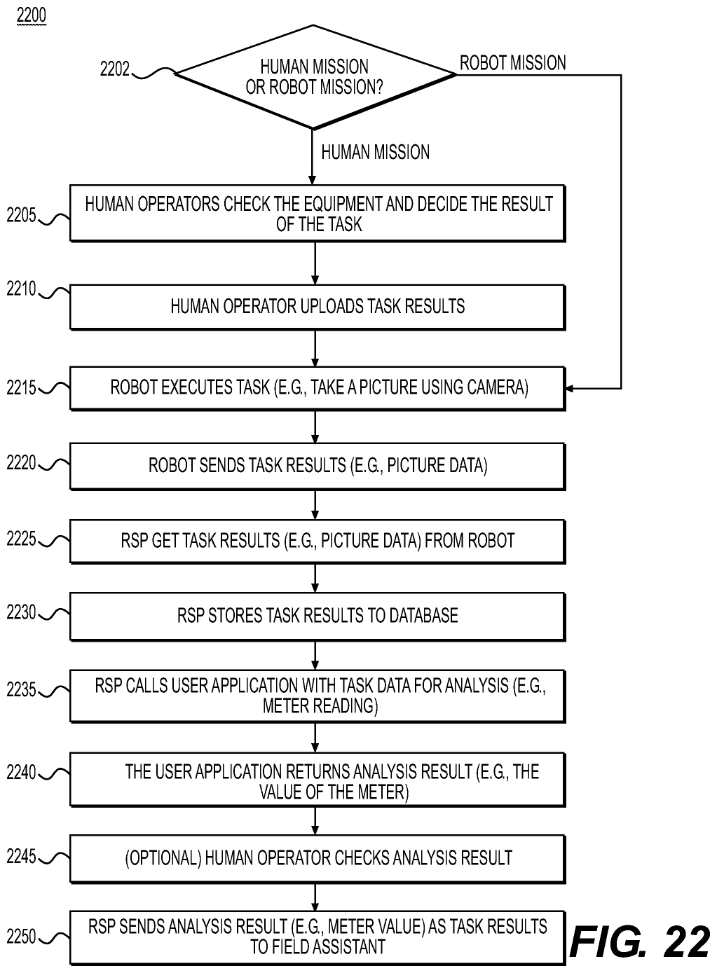

With reference to flowchart 2200 in FIG. 22, an example of assigning and managing missions is shown with reference to FIG. 21. For example, in Step 2202 of flowchart 2200, a human manager or an automated system (e.g., RSP 672) determines if a mission is tasked for a robot 1805 or a human 1806. This determination may be made based on the mission profile, or may be made based on historical data. For example, the mission profile may indicate one or more mission capabilities to complete the mission that may be satisfied by capabilities of a human.

If the mission is to be assigned to a human 1806, the human 1806 may check the equipment, e.g., a sensor, to determine a result of the task in Step 2205. For example, if the task is determining a reading on a pressure sensor, the human 1806 may read and record the value of the sensor. This value may be recorded digitally, e.g., via a handheld electronic device, or with a writing utensil and paper.

In Step 2210, the human 1806 may upload the results of the task. For example, the human 1806 may upload the results wirelessly or via a wired data port from the handheld electronic device. Alternatively, the human 1806 may input the results to a terminal at a headquarters upon completion of the mission.

If the mission is determined to be a mission for a robot 1805 in Step 2202, the robot 1805 may execute the mission based on the mission profile in Step 2215. For example, the robot 1805 may parse information from the mission profile, including factors, data, and/or mission capabilities associated with the mission, such as whether a sensor should be imaged, a valve position should change, or the like.

After the robot 1805 executes the mission, the robot may transmit the results of the mission in Step 2220 via a robot control system 1804. For example, the robot 1805 may transmit image data with information relating to a sensor reading, or information confirming that a valve was activated. This information may be sent wirelessly from the task location, or may be sent via a wired connection when the robot 1805 returns to home base. RSP 1803 (e.g., RSP 672) may receive the results of the task in Step 2225.

RSP 1803 may store any information (e.g. the task result) in a database 1807 in Step 2230. It will be understood that any information transmitted by the robot may be considered feedback, and may be used to define future missions. This information received during Step 2225 may also be used to determine whether additional missions should be scheduled, and the scope of those missions.

In Step 2235, RSP 1803 may determine that data in the result of the task should be analyzed. For example, the data may be related to a sensor, e.g., visual or sound data 1808, and may be analyzed by a manager 1801.

In Step 2240, a user application may return the results of the analysis. For example, the user application may automatically determine a reading of the sensor from the image data.

In Step 2245, the manager 1804 may review the image data and may confirm the analysis from the user application. For example, the image data may be of insufficient quality for the user application to provide an analysis with a sufficient degree of certainty.

In Step 2250, RSP 1803 may transmit the results of the task to a Field Assistant (FA) 1802 or user applications 2201. This may allow a user to view the results, and/or may provide feedback for modifying missions and/or creating new missions.

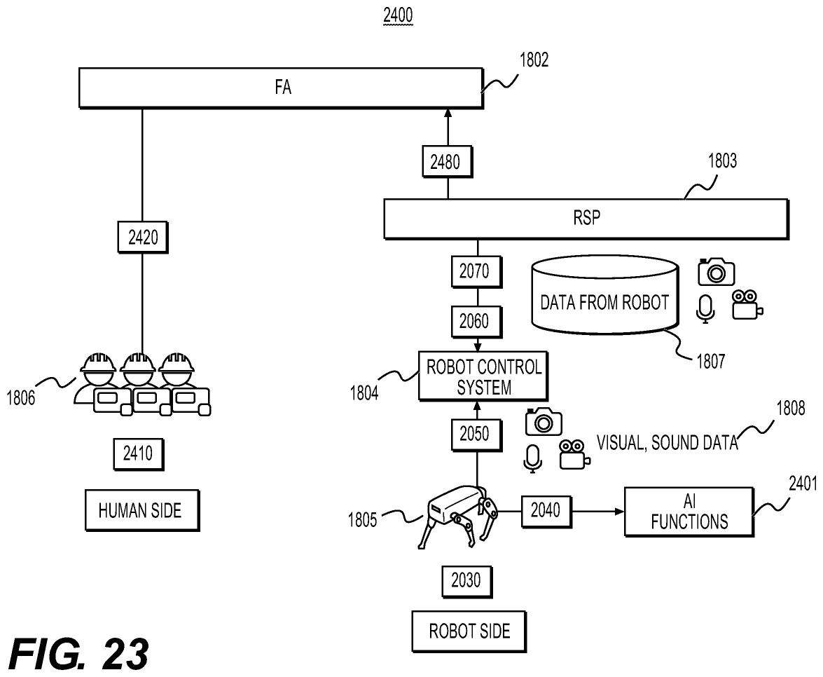

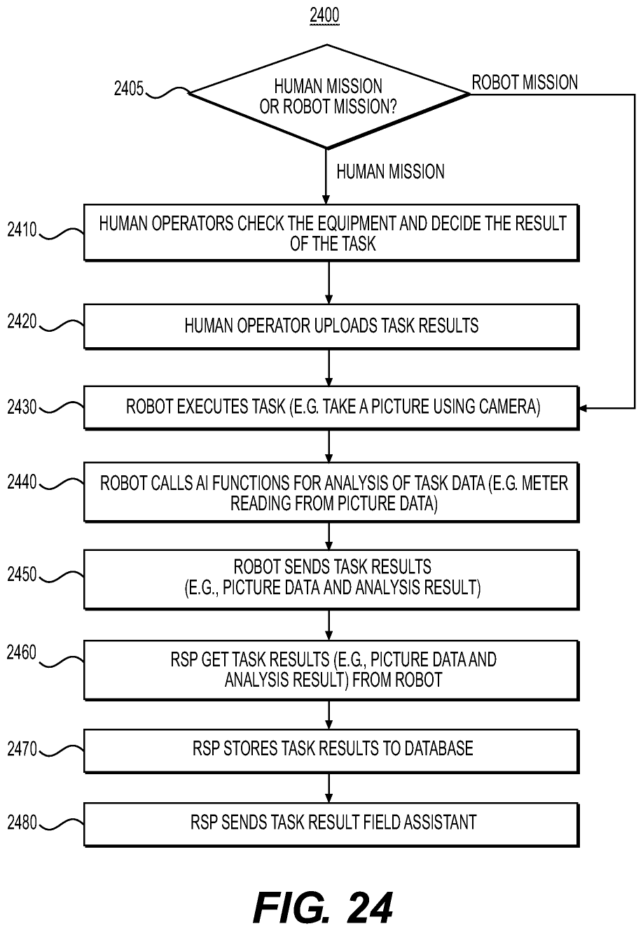

With reference to flowchart 2400 in FIG. 24, an example of assigning and managing missions is shown with reference to FIG. 23. For example, in Step 2405 a human manager or an automated system (e.g., RSP 672) determines if a mission is tasked for a robot 1805 or a human 1806. This determination may be made based on the mission profile, or may be made based on historical data. For example, the mission profile may indicate one or more mission capabilities to complete the mission that may be satisfied by capabilities of a human.

If the mission is to be assigned to a human 1806, the human 1806 may check the equipment, e.g., a sensor, to determine a result of the task in Step 2410. For example, if the mission includes determining a reading on a pressure sensor, the human robot 1806 may read and record the value of the sensor. This value may be recorded digitally, e.g., via a handheld electronic device, or with a writing utensil and paper.

In Step 2420, the human 1806 may upload or transmit the result of the task. For example, the human robot 1806 may release or transmit data relating to a sensor value using the handheld device. Alternatively, the human robot 1806 may access a terminal and transcribe data relating to the sensor value. This information may be transmitted to a central location, e.g., a Field Assistant (FA) system 1802.

If the mission is determined to be a mission for a robot 1805 in Step 2405, the robot 1805 may execute the mission in Step 2430, e.g., based on a mission profile. For example, the robot 1805 may parse information from the mission profile, including factors, data, and/or mission capabilities associated with the mission, such as whether a sensor should be imaged, a valve should be thrown, or the like.

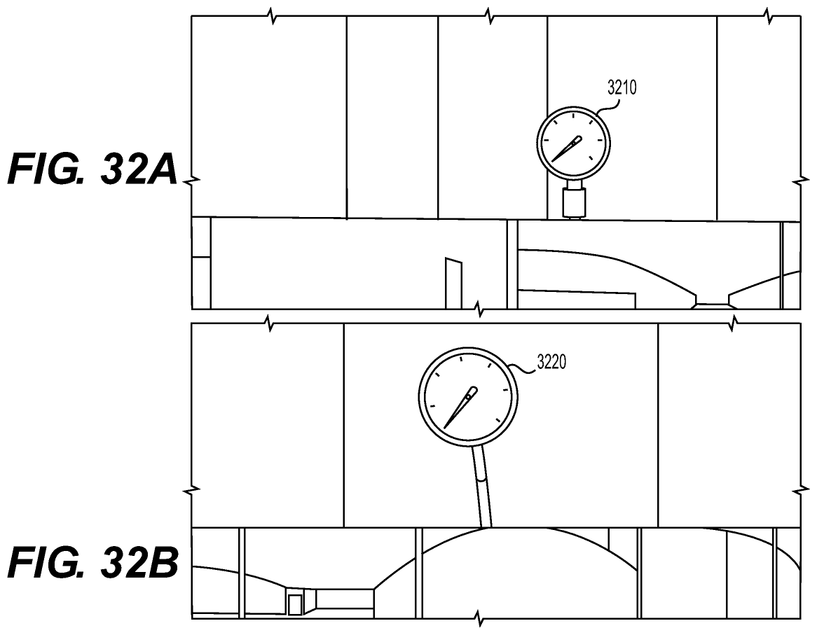

After the robot 1805 executes the mission, the robot 1805 may determine a result of performing a task associated with the mission in Step 2440. For example, sensors 3210 and 3220 in FIGS. 32A and 32B, respectively, may be imaged. The robot 1805 may query RSP 1803 to gain access to an artificial intelligence (Al) capability 2401 for determining the result of the reading from sensors 3210 and 3220, or any other image or audio data 1808 in FIG. 23. Alternatively, or additionally, the robot 1805 may have loaded thereon Al program 2401 for automatically determining a value of the sensors 3210, 3220 based on an image analysis. In this manner, a value of the sensor may be obtained.

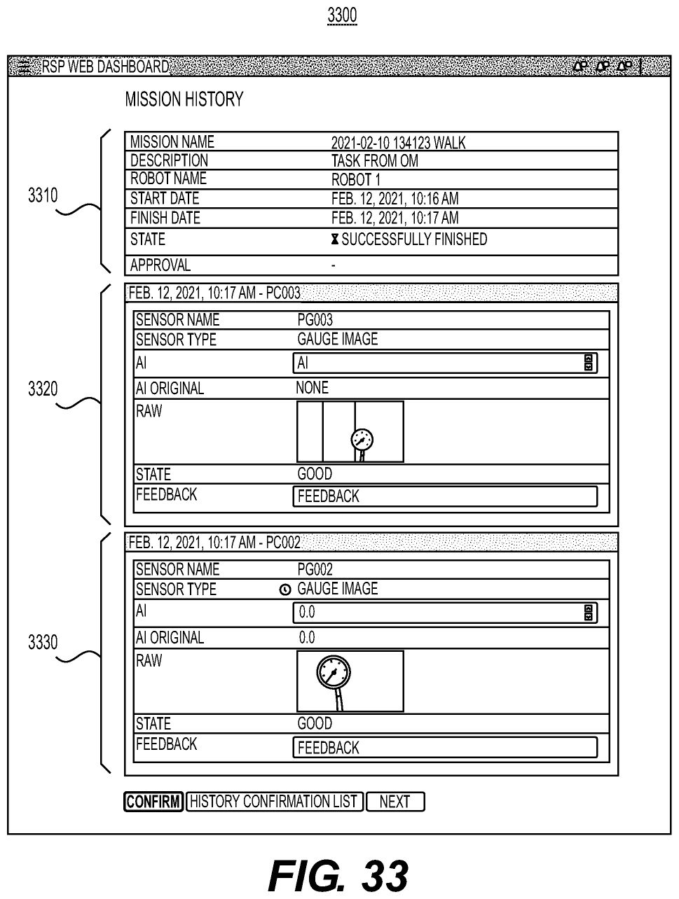

After determining a result of the task, the robot 1805 may transmit image data with information relating to a sensor reading in Step 2450. This information may be sent wirelessly from the task location, or may be sent via a wired connection when the robot returns to home base. RSP 1803 may receive the results of the mission in Step 2450. The information may include both the result, e.g., a reading of the sensor, and any raw data or information gathered during the mission, e.g., the image data of the sensor. It will be understood that any information transmitted by the robot may be considered feedback, and may be saved in a database 1807 and may be used to define future missions. This information received during Step 2450 may also be used to determine whether additional missions should be scheduled, and the scope of those missions. For example, feedback may be shown in mission history 3300 in FIG. 33. The feedback may include information associated with the task, e.g., first information 3320 associated with reading a first sensor information and second information 3330 associated with reading a second sensor information. In some instances, mission history 3300 may also include robot information 3310. Alternatively, or additionally, this information may be retrieved from a memory, e.g., historian 612 in FIG. 6. The robot data may be used to determine whether the robot was a suitable robot for achieving this mission (e.g., whether the robot performed the mission, or tasks therein, with superior or inferior results, reliability, efficiency in time or energy, or the like, as compared with other robots), and may be used as feedback to update planned or future missions, e.g., which robots are assigned to certain missions.

In Step 2460, RSP 1803 may receive the information from the robot. RSP 1803 may store any information in a database in Step 2470. In Step 2480, RSP 1803 may transmit the results of the mission to the Field Assistant (FA) system 1802. This may allow a manager to view the results, and/or may provide feedback for modifying missions and/or creating new missions.

Use of Artificial Intelligence and Machine Learning

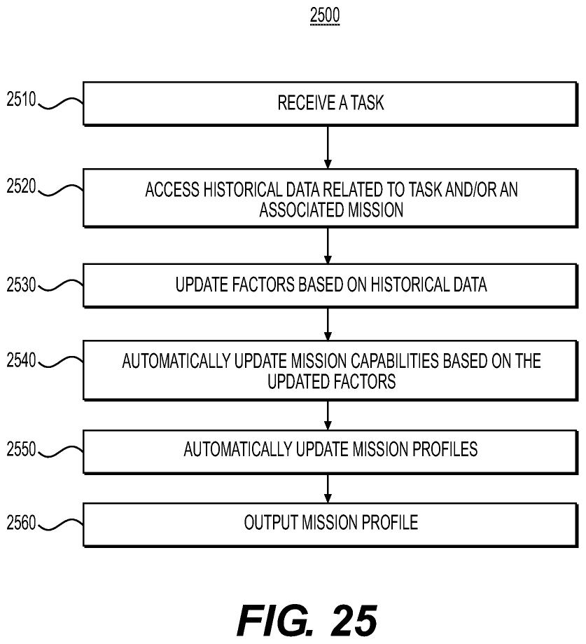

With reference to flowchart 2500 in FIG. 25, historical data may be used to define the mission. For example, a memory may store any one or more of tasks, factors, data, and mission capabilities. In some instances, one or more missions and tasks associated with the missions may be stored in a memory (e.g., historian 612). A task and/or mission may be accessed from the memory in Step 2510. Alternatively, or additionally, the task or mission may be input in the manner described with reference to Step 1110 in FIG. 11.

After establishing the task, factors related to the task (such as those factors described in Step 1120) may be determined by accessing historical data associated with that task in Step 2520. Alternatively, or additionally, RSP 672 may access operations management system 700 or another database to determine if factors associated with that task have been updated. For example, the task may include steps associated with finding and reading a pressure gauge. The historical data may indicate that the pressure gauge is an analog sensor. RSP 672 may access one or more databases and may determine that the pressure gauge was updated to a digital sensor.

In Step 2530, RSP 672 may access a storage (e.g., historian 612) to determine historical data relating to the data associated with factors of the task. Moreover, in the event the factors are updated based on new information associated with the mission, the data may be automatically updated to include the new data associated with these updated factors. For example, in the event the pressure gauge has changed from analog to digital, the data may include details for accessing information on the digital pressure gauge.

In Step 2540, mission capabilities that may be used to accomplish the mission may be determined and/or updated. The mission capabilities may be determined by accessing historical data. Alternatively, or additionally, mission capabilities may be automatically updated based on the revised factors and/or the revised data. For example, if the pressure gauge was changed from an analog sensor to a digital sensor, the mission capabilities for reading the sensor may change. In this instance, the mission capabilities may be automatically updated based on information in operations management system 700 and/or by accessing information on the Internet, e.g., via a manufacturer's website or the like.

In Step 2550, the mission profile may be automatically updated based on any new information determined in Steps 2510-2540.

In Step 2560, the mission profile may be output as described in Step 1150 in FIG. 11.

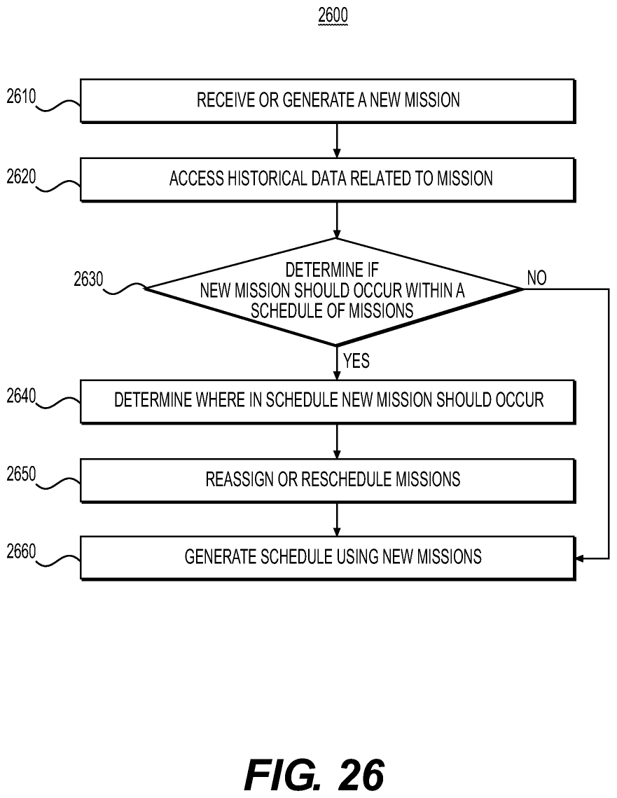

The flowchart 2600 of FIG. 26 describes a method of generating an updated schedule of missions based on historical data. One or more missions, each mission having a mission profile, may be received as described in Step 2610 in FIG. 26. As described herein, the mission profiles may be based on missions selected by a user. Alternatively, or additionally, artificial intelligence and machine learning using historical data may be used to determine the missions and mission profiles in Step 2610. For example, missions maintaining the facility may be assigned on a predetermined basis by a human or automatically by an operation management system or RSP 672. Once these missions are scheduled for a first time, however, the missions may be automatically received by RSP 672 from a memory, e.g., historian 612, in Step 2610. Furthermore, missions may be selected based on a new work instruction. For example, missions having a single task (e.g., check sensor, actuate button, turn lever, etc.) may be modulated, or combined, to create a mission having multiple tasks based on one or more task requests.

In some instances, RSP 672 may record a success rate and/or mission completion times for one or more missions supported by multiple robot types. RSP 672 may adjust the assignment of missions based on this historical data by revising the assignment algorithm to assign the missions to robots to perform the missions at a higher success rate, to more quickly complete the missions, or the like. In some examples, a mission may be determined to be inconclusive or otherwise deemed a failure if, e.g., a photo is taken with a below-optimal resolution. In this instance, RSP 672 may revise the assignment algorithm to schedule similar missions to a robot having a better imaging package. RSP 672 may also select a power consumption of all robots by adjusting the assignment algorithm to assign the missions to robots that will have lower or higher power outputs based on the power demands of each robot. For example, if high quality images are desired but these robots require high power, assigning a mission to a robot to deliver high quality images may increase the overall power of the robots.

Further, feedback may be sent to RSP 672 from sensors and robots assigned throughout the facility in Step 2620. Based on the feedback, missions may be generated to address maintenance issues that arise on a predetermined basis. For example, it may be determined that condensation forms on a particular pipe, and water continuously forms on the floor beneath the pipe. Feedback from a sensor or a robot may provide this information to RSP 672, and a mission may be defined (e.g., in flowchart 1100 of FIG. 11) to clean-up the water on a predetermined basis. For example, having water on the floor may change environmental factors, which could affect an entire fleet schedule. In this instance, cleaning the water on the floor may be assigned to be performed before other tasks in that area of the facility.

In Step 2630, it may be determined if the new mission should occur within a schedule of missions, e.g., missions which have previously been scheduled. If the new mission may occur within the schedule, it may be determined where in the schedule the new mission should occur. For example, as mentioned above, cleaning water on a floor may be scheduled before other nearby tasks. Alternatively, flowchart 2600 may proceed to Step 2660.

In Step 2640, it may be determined where in the schedule the new mission should occur. For example, this may be determined based on mission factors, data, and/or mission capabilities in the missions already scheduled and the new missions. For example, a mission may require traversing an area where water is on the floor, and the assigned robot cannot traverse water. A mission to clean the water may be scheduled beforehand.

In Step 2650, the missions may be reassigned or rescheduled as described herein (see, e.g., FIG. 28). Once the missions have been rescheduled, the revised mission schedule may be generated, for example, as described in Step 2860 of FIG. 28. Alternatively, a new mission schedule may be generated with those missions determined to not be part of a previously scheduled mission.

Use of Feedback for Defining, Assigning, and Managing Missions

With reference to flowchart 2700 in FIG. 27, the robot may receive feedback during a mission. During a mission, one or more sensors or other devices for gathering information may provide feedback in Step 2710. These sensors/devices may include an image sensor, a pressure sensor, or any other device. The sensors may be sensors associated with the facility and/or associated with one or more robots within the facility. The sensors may monitor the status, capabilities, or other information of a robot directly, e.g., a sensor mounted on the robot, or indirectly, e.g., a sensor associated with the facility. The feedback may include robot specific feedback. For example, the robot may provide battery status, health status (e.g., malfunctioning sensor), location within the facility, or other similar feedback. The sensors also may determine environmental information of the facility. For example, the feedback may include a pressure or a temperature of the environment. The feedback may also include a position of one or more objects within the facility. For example, imaging or location devices may determine a position of a robot, a human, or other objects within the facility. A human also may provide feedback, directly or indirectly. For example, the human may provide feedback via a portable handheld device or via a stationary terminal within the facility. Alternatively, or additionally, sensors may be attached to the human and/or may be embedded within the human robot's clothing or equipment. In this manner, both a robot and a facility may be monitored, and missions and/or mission schedules may be altered as needed.

In Step 2720, the feedback may be transmitted from the sensor or other device to RSP 672. Transmitting data from the sensor to RSP 672 may be done directly or indirectly. For example, as will be described herein, the sensor may be connected via a wireless or a wired connection to RSP 672. In some cases, the wireless connection may be intermittent due to predetermined communication schedules, or due to interference from objects throughout the facility. In this instance, feedback may be transmitted from the sensor to RSP 672 indirectly. This indirect communication may be via another robot, a human, or other communication interface.

In Step 2730, RSP 672 and/or a robot may receive the feedback. A user may monitor the feedback and may alter a mission or a mission schedule, or the mission or the mission schedule may be altered automatically by the robot or RSP 672. For example, the robot that received the feedback may automatically alter a mission based on the feedback. Altering a mission or a mission schedule based on the feedback is described herein (e.g., FIG. 11 or 25).

In Step 2740, RSP 672 may store feedback in a storage. This feedback may be used to define future missions. For example, environmental data in a mission profile may be updated based on the most recent feedback from a particular location. In other examples, the temperature of the facility may change consistently throughout the day, and environmental data may be updated based on timing.

In Step 2750, RSP 672 may transmit altered missions and/or an altered mission schedule to one or more robots. For example, based on the feedback received, the missions and or the mission schedule may be altered, and revised mission profiles may be transmitted to the robots accordingly. RSP 672 may transmit the altered missions or mission schedules to the robots in any manner described herein.

With reference to flowchart 2800 of FIG. 28, altering missions and/or mission schedules may be modified based on feedback. For example, this flowchart may apply to altering missions or mission schedules from Step 2550 in FIG. 25.

In Step 2810, feedback is received by a robot or RSP 672. Feedback may include information related to a factor of a task, data, mission capability, or a robot capability of the robot. In Step 2820, RSP 672 determines whether the feedback is feedback relating to one or more of a factor of a task, data relating to the factor, a mission capability, or a robot capability, or a combination of these.

In Step 2830, RSP 672 determines which missions the feedback affects. For example, the feedback may include a factor of a task. In this instance, a single mission, e.g., the mission associated with the task, may be the only mission affected by the feedback. If the feedback includes an environmental data, the feedback may affect multiple missions. For example, if the pressure in a certain area of the facility changes, this may affect multiple missions associated with that area. Feedback may also include the inability to access a certain location within the facility (e.g., based on size or facility restrictions), the presence of humans working in a certain vicinity (e.g., work performed by the robot may cause harm to the humans), broken or malfunctioning equipment (e.g., valves, sensors, buttons, etc.), the environment (snow, rain, gas, daylight, etc.), or the like. Missions may also be application dependent, e.g., missions may be assigned to a subset of robots based on the mission type (Robots A may be assigned to missions including button actuation, Robots B may be assigned to mission including moving a lever, etc.). Feedback and historical data may be used to optimize future missions, e.g., reassign future missions to different robots, such that future mission schedules may improve efficiency, reduce cost and energy usage, etc., based on robot usage.

In Step 2840, a mission profile of each mission that is affected by the feedback is modified by RSP 672. For example, the portion of the mission profile that is affected, e.g., the factor, the environmental data, the mission capability, or the robot capability, is modified.

In Step 2850, RSP 672 determines if the modification of the mission profile affects the mission schedule, for example the assignment of a robot, the timing of the mission, etc. If the answer is no, then the operation proceeds to Step 2870. If modification of the mission profiles does affect the mission schedule, then flowchart 2600 flows to Step 2860.

In Step 2860, the mission schedule is revised. For example, the missions may be reassigned as described in flowchart 2600 of FIG. 26, the timing of the missions changed, etc.

In Step 2870, the mission schedule or the revised mission schedule is generated and transmitted to the robots. For example, the mission schedule may be generated and transmitted as described in Step 1260 of FIG. 12.

Methods of Reassigning Missions

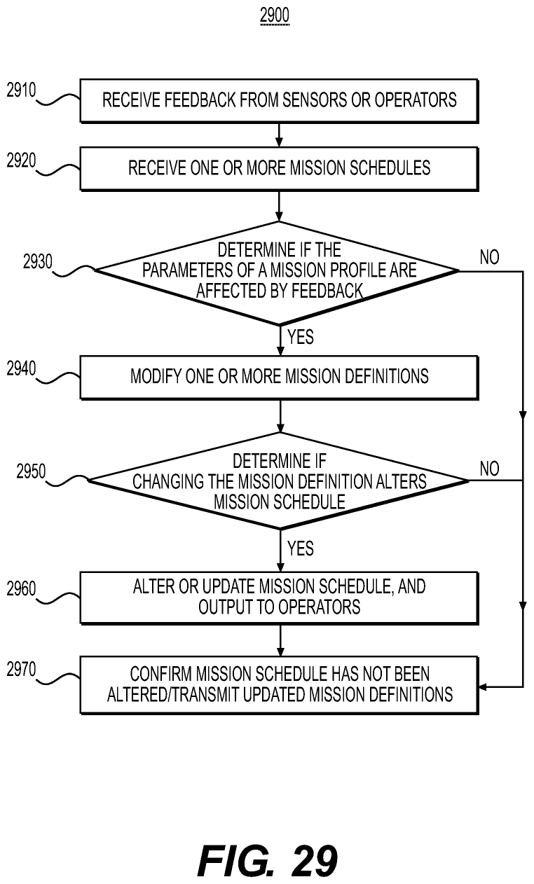

With reference to flowchart 2900 in FIG. 29, a method of reassigning missions is described. In Step 2910, feedback may be received in any manner described in flowchart 2700 of FIG. 27 or flowchart 2800 of FIG. 28.

In Step 2920, one or more missions or mission schedules may be received by an RSP 672. This may include any missions obtained during Step 1210 in assigning missions flowchart 1200 of FIG. 12, or any mission schedules generated an output in Step 1260. Alternatively, or additionally, mission schedules generated by a remote system, or a mission schedule received from a human, e.g., via an input device, may be received in Step 2920.

In Step 2930, RSP 672 determines if any of the parameters of any mission profile (factors, data, mission capabilities) are changed based on the feedback. If the mission profiles are unaffected, flowchart 2900 proceeds to Step 2970. If at least one mission profile is affected, flowchart 2900 proceeds to Step 2940.

One or more mission profiles are modified and updated by RSP 672 in Step 2940. For example, an environmental data feedback may alter environmental data in one or more mission profiles.

In Step 2950, RSP 672 determines whether changing the mission profile alters the mission schedule. For example, RSP 672 may determine whether the robot or robots assigned to each mission may continue to perform the missions based on the same mission schedule. If altering the mission profile does not change the mission schedule, flowchart 2900 proceeds to Step 2970. If altering the mission profile does change the mission schedule, flowchart 2900 proceeds to Step 2960.

The mission schedule may be altered or updated in Step 2960. For example, the missions may be assigned to a mission schedule in the manner described in flowchart 1200 of FIG. 12 and/or flowchart 2600 of FIG. 26. The new or revised mission schedule may be output and assigned to robots as in Step 1260 in FIG. 12.

In Step 2970, a confirmation message or alert may be transmitted to all robots in the mission schedule, a supervisor's display, or the like to confirm that the mission schedule has not been revised. In addition, mission profiles of one or more missions which were revised, but which did not affect the mission schedule, may be transmitted to respective robots. Alternatively, RSP 672 may determine that no confirmation message is necessary to be sent to the robots and/or the supervisor or other personnel in an attempt to decrease the amount of data transmissions. In some instances, missions may be designed such that robots have limited communication with RSP 672 to reduce cost, etc. In this instance, robots may be instructed (based on mission profiles and/or mission schedules) to operate independently to complete one or more missions unless an alert or other emergency occurs. In some examples, status checks may be sent periodically to or from RSP 672 to advise RSP 672 of the status of the robots and/or the missions. Based on this feedback, schedules may be modified as described herein.

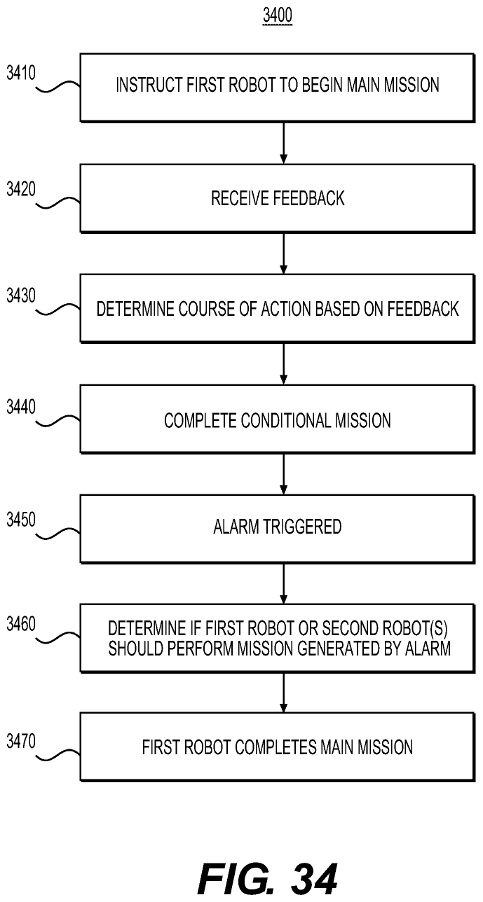

With reference to flowchart 3400 in FIG. 34, another method of reassigning a mission is described.

In step 3410, a first robot may be begin performing a main mission. In Step 3420, the first robot may receive feedback in any manner described herein. Based on that feedback, the first robot may determine a course of action in Step 3430. For example, the first robot may determine that it is incapable of performing the mission, or determine that it may be capable of performing a conditional mission (received from RSP 672 or preloaded on the robot) based on the feedback.

In Step 3440, the robot completes the conditional mission and begins performing the main mission again. In some cases, the robot may begin performing the main mission from where it left off, or the entire main mission may need to be performed again.

Additionally, in Step 3450, an alarm may be triggered, indicating an event occurring within the facility. In Step 3460, it is determined whether the first robot or one or more second robots should perform a mission generated based on the alarm, based on, e.g., a robot's proximity to the location, a priority of the missions assigned to all robots, or the like.

In Step 3470, the main mission may be completed by the first robot. The first robot may begin another mission, or may return to a shelter or other “base” area (returning to base may be included in the main mission or may be a separate mission preprogrammed to the robot).

While exemplary control systems for defining, assigning, and managing robot and robot fleets have been described, it will be understood that the particular arrangements of elements in these systems are not limited. As described herein, there is included a control system for defining, assigning, and managing robots and robot fleets. Defining, assigning, and managing various robots may be improved by the systems and methods described herein.

It will be apparent to those skilled in the art that various modifications and variations may be made in the disclosed systems and methods without departing from the scope of the disclosure. It should be appreciated that the disclosed systems may include various suitable computer systems and/or computing units incorporating a plurality of hardware components, such as, for example, a processor and non-transitory computer-readable medium, that allow the systems to perform one or more operations during a method in accordance with those described herein. Other aspects of the disclosure will be apparent to those skilled in the art from consideration of the specification and practice of the features disclosed herein. It is intended that the specification and examples be considered as exemplary only.

It should be appreciated that the various systems may include any computing device. The computing device may include input and output ports to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

In one embodiment, any of the disclosed systems, methods, and/or graphical user interfaces may be executed by or implemented by a computing system consistent with or similar to the descriptions herein. Although not required, aspects of this disclosure are described in the context of computer-executable instructions, such as routines executed by a data processing device, e.g., a server computer, wireless device, and/or personal computer. Those skilled in the relevant art will appreciate that aspects of this disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “computing device,” and the like, are generally used interchangeably herein, and refer to any of the above devices and systems, as well as any data processor.

Aspects of this disclosure may be embodied in a special purpose computer and/or data processor that is specifically programmed, configured, and/or constructed to perform one or more of the computer-executable instructions explained in detail herein. While aspects of this disclosure, such as certain functions, are described as being performed exclusively on a single device, this disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of this disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of this disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It will be apparent to those skilled in the art that various modifications and variations can be made to the disclosed system, methods, and devices without departing from the scope of the disclosure. Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for management of a robot fleet, the system comprising:
a plurality of robots including a first robot of a first robot type and a second robot of a second robot type; and
a robot service platform comprising:
a first data adapter corresponding to the first robot type and configured to transform mission feedback gathered by the first robot to a common data format compatible with the robot service platform;
a second data adapter corresponding to the second robot type and configured to transform mission feedback gathered by the second robot to the common data format;
a first control adapter corresponding to the first robot type and configured to transform common mission control information to first robot mission control information compatible with the first robot;
a second control adapter corresponding to the second robot type and configured to transform the common mission control information to second robot mission control information compatible with the second robot; and
a mission manager configured to:
select the first robot, from among the plurality of robots, to perform a selected robot mission among a plurality of robot missions based on capabilities of the first robot and features of the selected robot mission;
transmit first robot mission control information to the first robot via the first control adapter, the first control adapter having transformed the first common robot mission control information to the transmitted first robot mission control information; and
receive, from the first data adapter, mission feedback transformed by the first data adapter from data obtained by the first robot.

2. The system for management of a robot fleet of claim 1, wherein the mission manager is further configured to:
select the second robot, from among the plurality of robots, to perform the selected robot mission based on capabilities of the second robot and features of the selected robot mission;
transmit second robot mission control information to the second robot via the second control adapter, the second control adapter having transformed the first common robot mission control information to the transmitted second robot mission control information; and
receive, via the second data adapter, mission feedback gathered by the second robot.

3. The system for management of a robot fleet of claim 2, wherein the mission manager considers the first robot and the second robot for performance of at least part of the selected robot mission and selects the second robot to perform the at least part of the selected robot mission instead of the first robot.

4. The system for management of a robot fleet of claim 2, wherein the mission manager considers the first robot and the second robot for performance of at least part of the selected robot mission and selects the second robot to perform the at least part of the selected robot mission in cooperation with the first robot.

5. The system for management of a robot fleet of claim 2, wherein the second data adapter is distinct from the first data adapter, and the second control adapter is distinct from the first control adapter.

6. The system for management of a robot fleet of claim 1, wherein the received mission feedback includes one or more of information that the selected robot mission was fully completed, information that the selected robot mission was partially completed, information that the selected robot mission was not initiated, health information about the first robot, status information about the first robot, capabilities information about the first robot, photographs, video, environmental data, sensor readings, motion data about the first robot, and location data about the first robot.

7. The system for management of a robot fleet of claim 1, wherein the first robot mission control information transmitted to the first robot includes one or more of multi-step mission instructions or individual operation instructions, the individual operation instructions including one or more of navigate to a destination, take a photograph, take a video recording, take a sound recording, take an environmental measurement, take a temperature measurement of a substance, take a temperature measurement of the air, take a humidity measurement, determine an instrument reading, measure a presence or concentration of a gas or chemical, emit light of a particular wavelength, intensity, and/or emission pattern, emit sound of a particular pitch, intensity, and/or emission pattern, emit a radio frequency homing beacon, transmit stored data via a radio frequency or wireless data network, connect to a power source, connect to a radio frequency or wireless data network, connect to a data network port, modify a setting of a valve or other control, adjust a position of a valve, vane, locally controlled pump or drive, take a product sample, press a button, change a switch position, move an object, stop all operations, return to home, or activate a sensor.

8. A robot service platform for management of a robot fleet, the robot service platform configured to:
select a first robot, from among a plurality of robots, to perform a robot mission;
select, from among a plurality of data adapters, a first data adapter corresponding to a first robot type of the first robot, the first data adapter being configured to transform mission feedback gathered by the first robot to a common data format;
select, from among a plurality of control adapters, a first control adapter corresponding to the first robot type, the first control adapter being configured to transform common mission control information to first robot mission control information compatible with the first robot;
transmit the first robot mission control information to the first robot via the first control adapter, the first control adapter having transformed the first common robot mission control information to the transmitted first robot mission control information; and
receive, via the first data adapter, mission feedback gathered by the first robot.

9. The robot service platform for management of a robot fleet of claim 8, the robot service platform further configured to:
select a second robot, from among the plurality of robots, to perform the robot mission;
select, from among the plurality of data adapters, a second data adapter corresponding to a second robot type, the second data adapter being configured to transform mission feedback gathered by the second robot to the common data format, wherein the second data adapter is distinct from the first data adapter;
select, from among the plurality of control adapters, a second control adapter corresponding to the second robot type, the second control adapter being configured to transform common mission control information to second robot mission control information compatible with the second robot, wherein the second control adapter is distinct from the first control adapter;
transmit the second robot mission control information to the second robot via the second control adapter, the second control adapter having transformed the first common robot mission control information to the transmitted second robot mission control information; and
receive, via the second data adapter, mission feedback gathered by the second robot.

10. The robot service platform for management of a robot fleet of claim 9, wherein the robot service platform considers the first robot and the second robot for performance of at least part of the selected robot mission and selects the second robot to perform the at least part of the robot mission instead of the first robot.

11. The robot service platform for management of a robot fleet of claim 9, wherein the robot service platform considers the first robot and the second robot for performance of at least part of the selected robot mission and selects the second robot to perform at least part of the robot mission in cooperation with the first robot.

12. The robot service platform for management of a robot fleet of claim 8, wherein the robot service platform selects the first robot to perform the robot mission based on capabilities of the first robot and features of the robot mission.

13. The robot service platform for management of a robot fleet of claim 9, wherein the robot service platform selects the second robot to perform the robot mission based on capabilities of second robot and features of the robot mission.

14. The robot service platform for management of a robot fleet of claim 8, wherein the received mission feedback gathered by the first robot includes one or more of information that the selected robot mission was fully completed, information that the selected robot mission was partially completed, information that the selected robot mission was not initiated, health information about the first robot, status information about the first robot, capabilities information about the first robot, photographs, video, environmental data, sensor readings, motion data about the first robot, and location data about the first robot.

15. The robot service platform for management of a robot fleet of claim 8, wherein the first robot mission control information transmitted to the first robot includes one or more of multi-step mission instructions or individual operation instructions, the individual operation instructions including one or more of navigate to a destination, take a photograph, take a video recording, take a sound recording, take an environmental measurement, take a temperature measurement of a substance, take a temperature measurement of the air, take a humidity measurement, determine an instrument reading, measure a presence or concentration of a gas or chemical, emit light of a particular wavelength, intensity, and/or emission pattern, emit sound of a particular pitch, intensity, and/or emission pattern, emit a radio frequency homing beacon, transmit stored data via a radio frequency or wireless data network, connect to a power source, connect to a radio frequency or wireless data network, connect to a data network port, modify a setting of a valve or other control, adjust a position of a valve, vane, locally controlled pump or drive, take a product sample, press a button, change a switch position, move an object, stop all operations, return to home, or activate a sensor.

16. An adapter for management of a robot fleet, comprising:
a data adapter corresponding to a first robot type, the data adapter being configured to transform data gathered by the first robot to a common data format compatible with a robot service platform; and
a control adapter corresponding to the first robot type, the control adapter being configured to transform common mission control information to robot mission control information compatible with the first robot.

17. The adapter of claim 16, wherein mission feedback gathered by the first robot includes one or more of information that a robot mission was fully completed, information that the robot mission was partially completed, information that the robot mission was not initiated, health information about the first robot, status information about the first robot, capabilities information about the first robot, photographs, video, environmental data, sensor readings, motion data about a robot, and location data about the robot.

18. The adapter of claim 16, wherein the robot mission control information includes one or more of multi-step mission instructions or individual operation instructions, the individual operation instructions including one or more of navigate to a destination, take a photograph, take a video recording, take a sound recording, take an environmental measurement, take a temperature measurement of a substance, take a temperature measurement of the air, take a humidity measurement, determine an instrument reading, measure a presence or concentration of a gas or chemical, emit light of a particular wavelength, intensity, and/or emission pattern, emit sound of a particular pitch, intensity, and/or emission pattern, emit a radio frequency homing beacon, transmit stored data via a radio frequency or wireless data network, connect to a power source, connect to a radio frequency or wireless data network, connect to a data network port, modify a setting of a valve or other control, adjust a position of a valve, vane, locally controlled pump or drive, take a product sample, press a button, change a switch position, move an object, stop all operations, return to home, or activate a sensor.

19. The adapter of claim 16, wherein the adapter is configured to communicate with robots of a specific type or robots produced by a single manufacturer.

20. The adapter of claim 16, wherein the adapter is configured to communicate with robots of multiple types or robots produced by multiple manufacturers.
